(19) United States
(12) Patent Application Publication
(10) Pub. No.: US 2015/0256679 A1
(43) Pub. Date: Sep. 10, 2015

(54) Electronic Message Aggregation and Sharing System and Apparatus

(71) Applicants: J. Stephen Burnett, Wrightsville Beach, NC (US); Paul Wilkinson Dent, Pittsboro, NC (US); Lawrence D. Zirbel, Winter Park, FL (US)

(72) Inventors: J. Stephen Burnett, Wrightsville Beach, NC (US); Paul Wilkinson Dent, Pittsboro, NC (US); Lawrence D. Zirbel, Winter Park, FL (US)

(21) Appl. No.: 14/201,807

(22) Filed: Mar. 8, 2014

(51) Int. Cl. H04M 3/533

(52) U.S. Cl. CPC H04M 3/533

(57) ABSTRACT

In one aspect of the invention, an improved messaging service is described comprising a server for receiving messages from a first subscriber addressed to one or more second subscribers and storing them in a scrambled form on the server along with security tokens specific to each message and recipient subscriber to facilitate unscrambling only by the intended recipient subscribers.

In a second aspect of the invention, a subscriber terminal is described for precalculating security tokens corresponding to each of a number of yet-to-be received messages and transmitting the security tokens to a server for scrambling said messages even when the receiving subscriber terminal is offline.

A new-message originating terminal also receives from the server a precalculated and prestored security token for each of a number of intended recipients of the new message and combines them with a locally generated security token to form header information included with the new message.

### BACKGROUND

The present invention relates to electronic messaging systems and in particular to voice messaging systems such as voicemail.

Apparatus for recording telephone calls received when the subscriber is away from his telephone has existed well prior to the development of the Internet and even before the widespread use of digital technology. The earliest systems comprised the use of magnetic recording tape.

With the emergence of cellphones, the now widespread use of digital voice technology allowed cellphone systems to record digitized voice messages in computer-type electronic memory for later replay by the subscriber. Landline telephone systems also now record voicemails digitally in electronic memory. The messages recorded in such electronic memories may actually be transferred back to magnetic media, such as hard disks, which are now much more reliable and have much more capacity than earlier reel-to-reel recording systems.

Voicemail services are commonly provided to a telephone subscriber by a landline or cellphone carrier licensed to provide telecommunications services by a national telecommunications authority, and in those cases the digital voice messages are stored on computer systems located at the carrier's premises. Messages may be offered for storage when a call to a subscriber goes unanswered, or when a second subscriber dials directly into the voice mailbox of a first subscriber to leave a message without ringing the first subscriber's phone. Older technology of answering machines which can be located at the subscriber's premises still exists, the machines switching on automatically when the phone is not answered after a certain number of rings and then answering the call and prompting the caller to leave a recorded voicemail message.

A subscriber accesses voicemail systems in a number of ways. In the case of subscriber-owned answering equipment as just described in the previous paragraph, he simply presses the replay button. Some, but not all, answering machines allow remote access whereby a user can dial in from another phone and command replay by entering a code on the telephone keypad.

In the case of landline phone systems in which the carrier provides the voicemail service, to retrieve voicemails, the subscriber dials a special voicemail retrieval number, which then prompts him to enter his telephone number and a password in order to retrieve voicemails. Other voice prompts may be given to the user to take actions such as electing to save or delete a message.

In the case of cellphone voicemail systems, the procedure has been simplified to merely pressing the #1 key, which causes the cellphone automatically to dial the cellphone voicemail system, and no password entry is necessary, as cellphones already employ sophisticated electronic authentication procedures based on cryptography.

A person may have a number of telephones and therefore voicemail systems by which he can be reached; for example:
One or more home phone numbers (fixed, landline or equivalent via cable or satellite)
One or more work or office phones (fixed, landline)
One or more cellphones (e.g. a personal cellphone and a business cellphone)

The problem that then arises for communicating with such a person is that one would preferably want to know where he is in order to call him. In the case of a wrong guess, a voicemail might be left on a voicemail system which the person may not check for several days. Thus improvements to voicemail systems would be welcomed whereby a message left for a person on any voicemail system would be sure to be promptly retrieved by that person wherever he is.

In addition to the method afforded to the subscriber for retrieving voicemails, namely dialling a specific voicemail number provided by the subscriber's telephone carrier and responding to voice prompts with keypresses to select options, it is possible that certain voicemail servers provide electronic signals on the telephone line to indicate the presence of voicemail messages; however, these signals are not necessarily standardized or published, and are likely to be different between different carriers, or non-existent. For example, it cannot easily be assumed that such voicemail signals, if any, are the same or even known for a telephone located in Mexico or Canada as opposed to the US, but yet it is still conceivable that a subscriber in the US could wish to listen to voicemails left on a phone number in one of those countries.

If a subscriber's service provider of both his landline service and his cellphone service is the same carrier, then that carrier has sufficient knowledge of the operation of both of his systems and sufficient access to them to modify them if necessary to develop a new voicemail system offering voicemail aggregation across all of a user's mobile or fixed subscriptions provided by that same carrier. Systems provided by certain carriers indeed exist to aggregate voicemails from a landline number and a cellphone number, and to make them accessible via the Internet to a fixed computer such as a PC or a mobile computer such as a smartphone. However, there is usually an additional subscription charge for such a service, and it is not possible to aggregate voicemails across different service providers. It is not, for example, possible in the prior art to login to a webpage provided by ATT and see voicemails left on a Verizon phone, or vice versa. Moreover, a 3rd party has not necessarily had access to convenient, documented and standardized digital interfaces with the carriers' servers to provide such a system. Improvements are therefore required to allow a subscriber to aggregate voicemails when, for example, the service provider for his cellphone and landline service are not the same, or when the landline providers for his home and office phones are different. Moreover, in the absence of a single carrier being motivated to provide such a service, it would be desirable if a 3rd party could step into the void and develop such a system.

Other deficiencies of current voicemail systems include occasional unintelligibility of some important piece of information, such as a phone number, left in a voicemail. Thus means to enhance intelligibility for replay would be welcomed.

Current voicemail systems also do not easily allow messages to be shared with others. In general, once the subscriber has listened to a message, it is deleted unless he elects to save it for a limited time; but there is no convenient means to forward the message to other potentially interested parties. Moreover, the subscriber is periodically required to resave saved messages to prevent deletion. This is inconvenient, as all saved messages must normally be listened to again to resave one of them.

The sentiment has sometimes been expressed that “voicemails are trapped within the telephone system”, making them difficult to extract or share.

If calls are decoupled or untrapped from the phone system and forwarded to a new voicemail service instead, it becomes feasible to contemplate sharing them with others, using social media. However, despite the subscriber not then using the phone company's voicemail service, he will most likely not see a reduction in his monthly bill, as voicemail is often bundled with other services.

One method for posting voicemails described in the art is for the user to subscribe to such a new voicemail service, and empower the new voicemail service to post voicemail messages to social media on his behalf. One problem with this method is that there is then little control by the user over where on a particular social site the message will be posted. If the user terminal is a smartphone, it has a small screen that makes it inconvenient to have two webpages open at the same time, one to a social site and another to a voicemail server. Moreover, if the user terminal is a Plain Ordinary Telephone, then it does not display webpages at all. Therefore a single Man-Machine-Interface for retrieving or sharing voicemails does not work conveniently for all types of user terminal and consequently there is a need for new methods and apparatus to overcome the above deficiencies of the current art and to permit the user to retain the voicemail systems provided by his various telephone companies.

Telephone calls require that the receiving party be available at exactly the same time as the calling party. However it is apparent, through the growing use of “texting”, that people prefer to send messages to a recipient at any time convenient to the sender and that recipients prefer to receive messages that they do not have to absorb immediately. The inconveniences of current voicemail systems compared to the convenience of text messages are resulting in decline in the use of voice in favor of text, despite the greater effort and time required to type a message. This decline can potentially reverse if voice messaging is provided that avoids the inconveniences of current voicemail systems to provide a system for voice messaging that is as convenient to use as text messaging. Therefore there is a need for improved voice messaging systems

It is also desirable that voice messaging systems provide some kind of guarantee that only the recipients to whom messages are addressed will receive and be able to listen to the messages. The development of such a delivery guarantee that functions when some or all message recipients are off line requires improvements over current art which will be described herein.

### SUMMARY

A voicemail aggregation service and apparatus is provided that has the ability to aggregate voicemail messages left on substantially any existing voicemail system for any phone belonging to and designated by a subscriber to the service, including phones having subscriptions for service with different carriers. In addition, a voicemail program resembling an e-mail program is provided to allow the creation of voicemails using a Personal Computer, SmartPhone, Tablet or any other such suitable subscriber-related computing device that may become available, and to address and deliver the created voicemails to other subscribers indicated by either phone numbers or e-mail addresses or newly-created voicemail addresses which could be of either form.

The apparatus comprises a server computer connected to the internet and, if necessary, to phone lines, in such a way that it can be accessed by subscribers to the service to compose, retrieve, save, delete or share voicemails or other messages, the server computer in turn being able to access the subscriber's existing voicemail systems either by phone or internet connection, as appropriate.

The server stores voicemails and other messages in a scrambled form that only intended recipients can unscramble, thus avoiding the server becoming a high security risk.

When the user authorizes the inventive apparatus to aggregate his messages automatically, he provides all the credentials necessary for the apparatus to access his message systems to store, retrieve and handle his messages.

To ensure that voicemail messages transmitted from the sender to be stored on a server and then subsequently transmitted from the server to one or more recipients may only be received by the intended recipients, a security system is described. Each registered subscriber generates and stores in his computer a set of random numbers and scrambles them to obtain a bit pattern called a Token. The Tokens are transmitted to the voicemail server in advance of being needed so that they are available to be used even when the subscriber is offline. The server maintains a number of such Tokens per registered subscriber corresponding to the number of as yet unreceived messages for which the subscriber has requested server memory space, each Token being intended to be used once for each message transmitted or received in the particular manner described herein.

The description herein is principally directed to explaining how voicemails are handled, although it may be realized that the principles disclosed may also be applied to other message systems such as e-mail, in which the attachments may comprise text, audio or images. If the use of videophone becomes more widespread, and voicemails follow suit and include video images as well as audio, the system described should be understood to be easily generalized to include multi-media messages.

When necessary for a particular existing voicemail system, the inventive server parses the complete voicemail replay from that system automatically into individual messages, when the voicemail system itself does not provide such a facility, and stores the individual messages as separate, annotated files in a suitable audio file format such as .WAV. The subscriber may then log into the inventive apparatus to view all voicemails that have been aggregated together from all his voicemail services, including those provided by different, unrelated telephone companies, and the subscriber may retrieve a hyperlink to any of the aggregated voicemails selected by him. The subscriber may then post the link to other media, such as by embedding it in an e-mail or by posting it on a social site at a location on the social site selected by him extemporaneously, thereby making the message available to other parties. In order to perform the latter with the minimum number of keypresses, a second aspect of the invention comprises inventive software (an “App”) that may be downloaded from the inventive server to the subscriber's smartphone or computer, the inventive App providing a convenient man-machine interface by which the user may, in one implementation, click on a displayed symbol to select the message, a link to which to insert into an e-mail or post to a social site, the App then performing automatically the steps of retrieving the active link IP-address byte string from the voicemail server and embedding it where designated. In another implementation, while composing a post on a social site using an editor, the user may select an option from a dropdown list provided by the editor to insert a hyperlink to a voicemail, the App then performing automatically the steps of displaying a selection of voicemails in a pop-up window, noting the voicemail selected by the user, closing the pop-up window and then retrieving the hyperlink string from the inventive voicemail aggregation server and embedding it where designated.

When other parties log into the social site and click on the link, the opportunity is presented for the inventive server to deliver revenue-generating advertisements in a way that is unobtrusive to the objective of accessing the message. This enables a basic version of the service to be provided to many subscribers free of charge.

In addition, a man-machine interface may be provided that enables the user to instruct the inventive server to make quality-enhancing edits to stored audio files in order to improve intelligibility, such as the ability to partially rewind and replay a section, change the volume or frequency response, or process out background noise using any suitable noise reduction algorithm.

A novel piece of hardware is also described, comprising an internet-attached answering machine which facilities the task of collecting voicemails in otherwise intractable cases where no voicemail service from the telephone carrier is available.

### BRIEF DESCRIPTION OF THE DRAWINGS

FIG. 1 illustrates a simplified sequence of voice prompts that occurs in accessing a conventional wireline voicemail service

FIG. 2 is a block diagram of an inventive server architecture for performing message retrieval from unrelated message systems.

FIG. 3 shows the information flow for posting a voicemail to social media.

FIG. 4 shows a web-appliance for untrapping voicemails

FIG. 5 shows a screenshot of a man-machine interface for Voicemail Express

FIG. 6 shows message origination operations at a subscriber terminal

FIG. 7 shows message reception operations at a subscriber terminal

FIG. 8 shows a recipient-specific message header

FIG. 9 shows a possible pseudorandom number generator

FIG. 10 shows a possible scrambling unit

### DETAILED DESCRIPTION

This disclosure is related to U.S. patent application Ser. No. 13/796,990 filed on 12 Mar. 2013 and having the same inventors.

For conciseness, a number of contemporary expressions are used herein, which are defined as follows:

An “App” means an Application Program which can be selected to be installed by a mobile phone user on his mobile phone after manufacture, for example by downloading it from the Internet. An App may be free, or might be provided upon payment of a nominal sum of money by credit card or online payment service such as PayPal. The term “App” is also used herein to apply to such programs intended for fixed computers such as Personal Computers (PCs) or portable computers such as laptops, IPADs or Tablets.

An “OS” or operating system means the lowest level or core software provided on a user terminal such as a PC or smartphone, one purpose of which is to provide a level of abstraction to mask hardware differences between different devices from higher level software. The OS usually provides a number of reasonably well documented APIs or Application Program Interfaces that another programmer of higher level software can use without being concerned about hardware differences between different devices.

A “server” is a computer or bank of computers connected to the Internet, the purpose of which is to transmit digital data over the Internet simultaneously to multiple user terminals that are browsing the internet, the data representing webpages, movies, sounds, text or any other form of information that can be represented digitally. The webpages may be fixed or dynamically composed depending on the application and depending on the intended user destination.

A “carrier” or “service provider” means an entity licensed by the FCC in the US or equivalent organization in a foreign country to provide telecommunications services, typically telephone services, to the public in that country in return for payment.

“Voicemail system” or “Voicemail service” means an arrangement associated with a telephone number to record calls received when a call to the number goes unanswered.

“Call forwarding” means an arrangement associated with a telephone number to redirect a call to a different, predetermined telephone if calls to the number go unanswered. Thus the subscriber must choose whether he wants unanswered calls to a given number to go to voicemail or to be forwarded to another telephone.

“Social Media” or “Social Sites” refers to any website which a user might log into or visit to exchange messages with others having like interests. E-mail services may be considered to fall within the definition of “Social Media”. Facebook, Linked In, Myspace and suchlike websites are examples of “Social Sites”

A “hyperlink” means an Internet address (IP address) that directs a web-browser to data stored on the same or a remote computer which is accessible over the Internet. A hyperlink may be identified to a reader by a visible, human-meaningful text string while having a hidden, computer-meaningful web address string.

“Skype” refers to a well known brand of Voice-over-Internet services which allows telephone calls to be placed via a digital internet connection rather than an analog telephone line. The calls are converted between analog and digital at the Skype caller's location, transmitted digitally over the Internet to a Skype concentrator local to the area of the called number, and then converted between digital and analog once more for delivery over the local analog telephone network if the called subscriber is not also a Skype user.

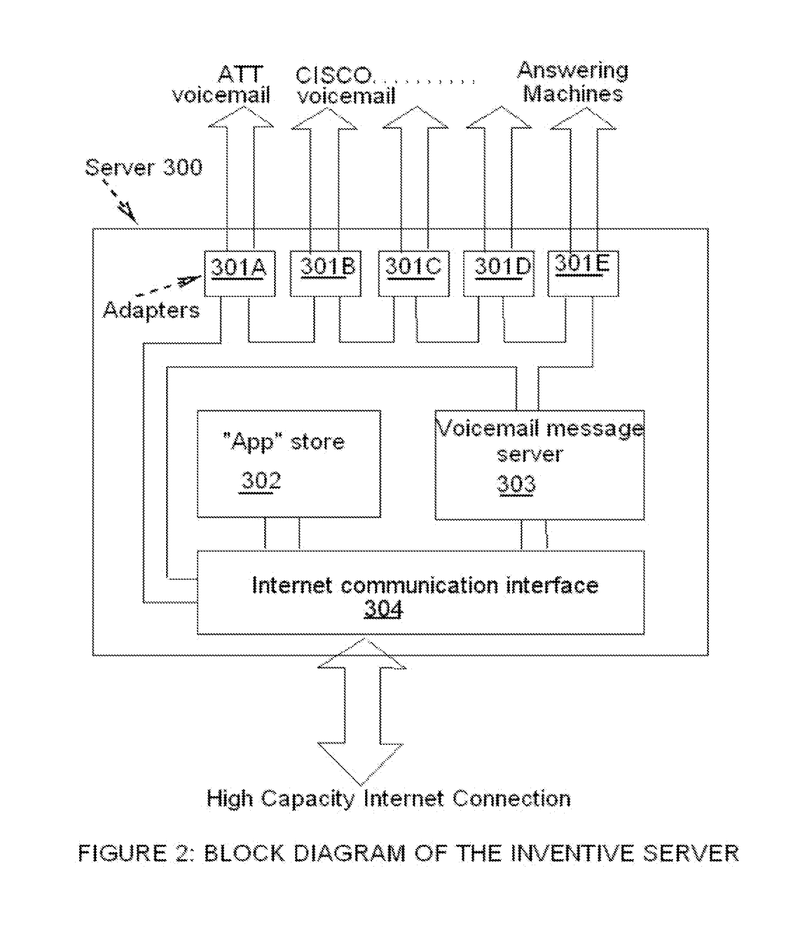

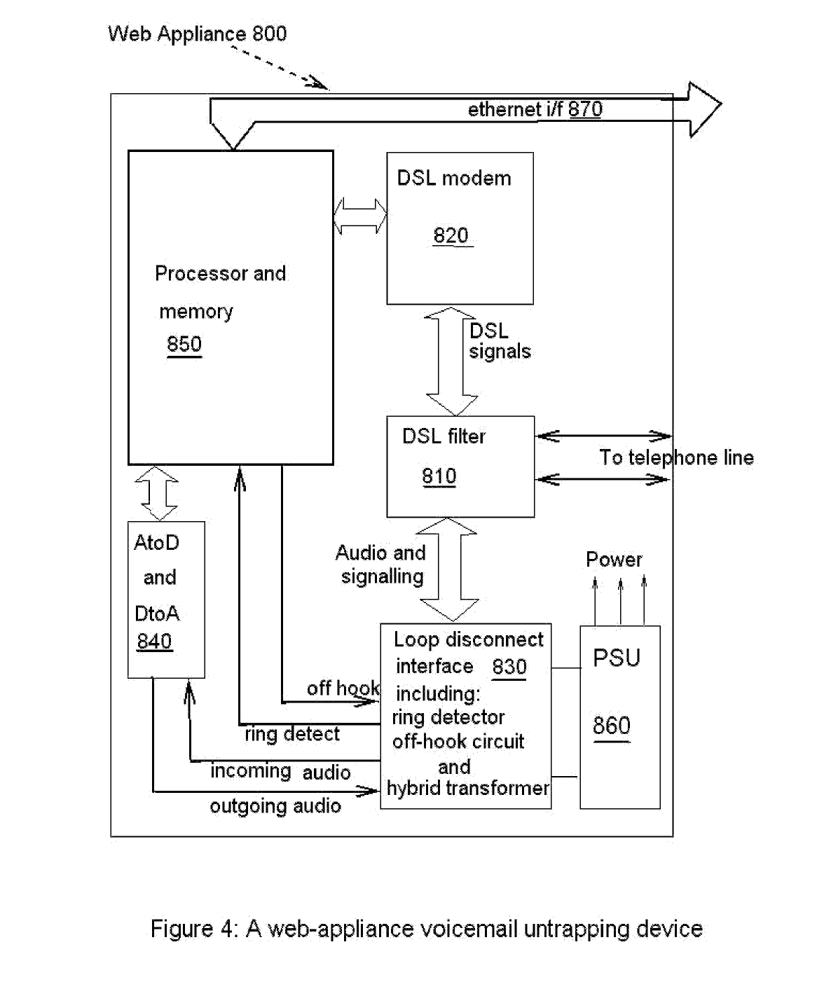

In a first aspect, an inventive voicemail aggregation device will be described with the aid of FIGS. 2 and 4, for aggregating voicemails from different, unrelated vociemail systems, and which may have adapters configured to interface with every voicemail system designated by a registered subscriber, even when those voicemail systems are provided by different carriers. The inventive voicemail aggregation device collects voicemails left on any of the subscriber's voicemail systems for any of his designated telephones, even when those telephones are served by different carriers, or, in the absence of a telephone having a voicemail service, the inventive voicemail aggregation device can perform collection of a voicemail itself by having unanswered calls forwarded to it, or, if the device is co-located and associated to the telephone, may forward the voicemail message to another device for storage, optionally after temporarily recording and storing it itself. It may be appreciated that devices that communicate digital information may incorporate buffer memories of any size to bridge timing differences between the operation of one device and the operation of another. At one extreme, data received by one device corresponding to a digitized voicemail message may be substantially immediately forwarded to another device, while at the other extreme an entire voicemail message may be recorded in buffer memory before forwarding to another device. The choice of buffer size is not material to the invention, and is selected based on timing considerations.

A second aspect of the invention comprises an App which may be downloaded to a mobile phone, fixed PC, Tablet, IPAD, laptop or any other suitable fixed, portable or mobile user terminal, the inventive App providing a convenient Man-Machine-Interface by which the user can cause the combination of his terminal and the inventive voicemail device to perform a variety of useful functions, such as displaying all voicemails received and selecting to listen to, save, delete or share them.

A third aspect of the invention comprises using the inventive App and the inventive voicemail aggregation device to post on Social Media a hyperlink to a selected message left by a second party for the first party (the subscriber) and which is stored on the inventive voicemail aggregation device such that, upon another internet user (a third party) reading the post and clicking on the hyperlink, the message is transmitted and played or displayed to the third party. A device which presents webpages over the internet simultaneously to many web-browsers is commonly called a “server”. One implementation of the invention comprises using such a server, which can be established by a party other than a telephone service provider to provide an inventive voicemail aggregation service to registered users.

A fourth aspect of the invention comprises displaying advertisements in a pop-up window on the third party's user terminal when the third party clicks on the hyperlink posted on the social medium.

A fifth aspect of the invention comprises using the inventive App to compose voice messages with or without the use of a telephone, to address those messages to one or more recipients designated either by a telephone number, e-mail address or other form of address, to scramble the composed messages using a random key and furthermore to scramble the key in a recipient-specific way using a recipient-specific Token such that the message will only be readable by the intended recipients.

Each of the above aspects may furthermore have an inventive apparatus aspect, an inventive software aspect, an inventive method aspect and an inventive business aspect.

The invention may comprise in the first aspect an internet server having adapters, which are described further later with the aid of FIG. 2, and which are configured to interface with every voicemail system used by a subscriber, including voicemail systems provided by different, unrelated telephone service providers. The following description is an example of the functions performed by such an adapter in an exemplary case.

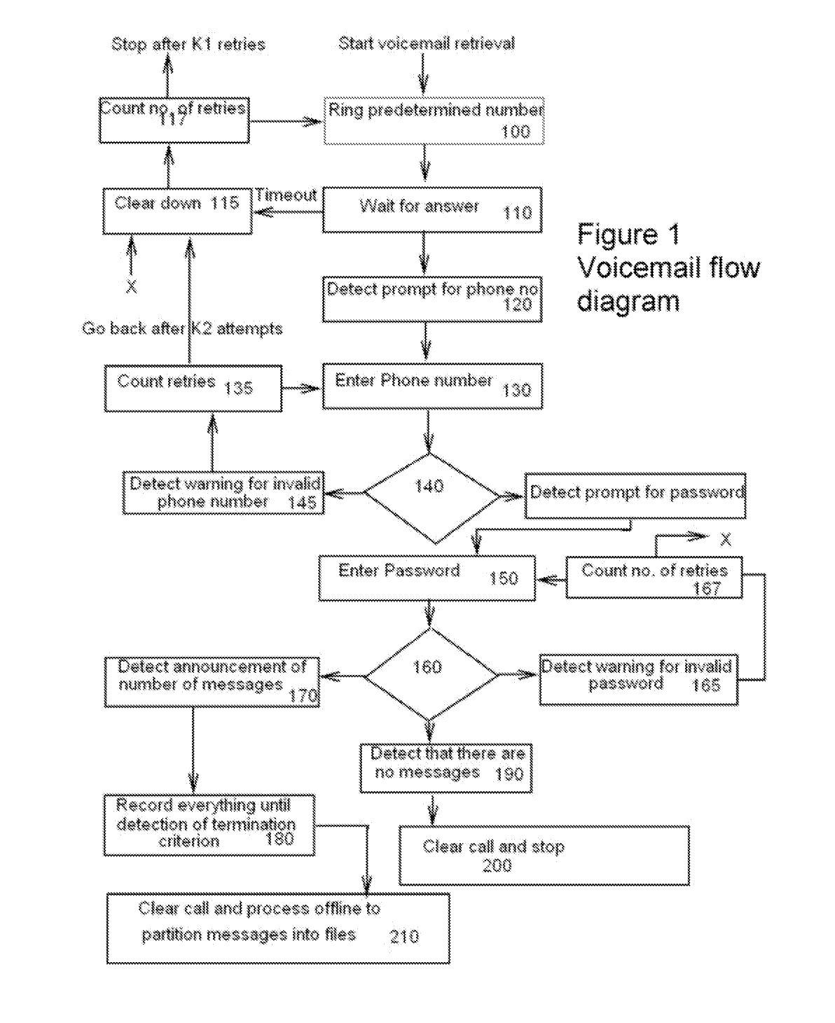

FIG. 1 shows the typical flow diagram for navigating through a voicemail retrieval system using voice prompts. Voicemail systems belonging to different operators may exhibit a different flow, but the example used is based on a simplified form of the voicemail provided for landline phones by ATT, which was formerly established by Bell South.

In the absence of a more efficient method, the invention aims automatically to perform the actions that would be performed by a human subscriber to navigate through the state diagram of FIG. 1. In a first implementation, this action may be performed by using a computer program or “App” installed on a computer or smartphone belonging to the subscriber. When installed, such an App picks up software hooks to the keyboard and display Application Program Interfaces (API's) provided by the Operating System (OS) and gets access to all the communications APIs likewise. In a second implementation, the subscriber delegates this action to be performed by the inventive server by providing it with the credentials necessary to log into his voicemail systems. The use of one implementation or the other may be selected on a per-subscriber and per voicemail system basis depending on which is most suitable for his voicemail systems or personal preferences.

Referring to FIG. 1, in the first implementation, upon the user clicking on a “Get voicemail” Icon, the App starts executing at step 100. Alternatively, a timer can be set to determine a periodic polling for new voicemails. In the case the voicemail box in question is for the mobile phone on which the App is installed, the mobile phone may receive an alert when a new voicemail is available, the alert being intercepted by the App and causing it to take the desired action, thus obviating the need for periodic polling. The App has a predetermined method to use to access each voicemail service. In the example under discussion, this might be to place a call to a prestored number. For example, for an ATT voice mail service for a phone located in the center of North Carolina, the number to be called is 919 918 2095. The smartphone, other user terminal or server thus rings this prestored number in step 100. The calling device waits for an answer in step 110. When answered, cellphone and other phone systems provide specific signalling to indicate when a call is answered. If the call is not answered within a timeout period, transition is made to step 115 which clears down the call, then in step 117 the number of retries is counted, and a return to step 100 to try the call again is made if the number of retries is within a preset limit. If on the other hand the signal is received that the call has been answered, transition is made to step 120 where a voice recognition algorithm listens for a prompt to enter the subscriber's phone number associated with the voicemail system. For simplicity, a number of steps that may be needed at sign-on have been omitted from this exemplary voicemail flow diagram. Upon detection of the appropriate voice prompt, transition is made to step 130 and the subscriber's prestored phone number is issued by DTMF tone signaling or its digital equivalent.

After issuing the phone number, at least two possible outcomes could be anticipated. One possible outcome is that, for one reason or another, the phone number is not recognized as valid. Another possible outcome is that the phone number is accepted. The voice recognition algorithm continuously attempts to detect both of the predetermined announcements for these two possible outcomes and ultimately decides which outcome occurred. If the phone number was deemed invalid, a return is made through steps 145 and 135 to re-enter the phone number, with the number of retries being counted at step 135. After K2 unsuccessful tries, the call is cleared down at step 115 and the call may be re-dialled. If the phone number was deemed valid however, detection of the prompt for a password advances the state to step 150 where a password will be issued by DTFM signalling or its digital equivalent. At step 160, two possible outcomes can be anticipated; either the password is deemed invalid at step 160 with consequent backtracking through step 167, or else the password is accepted, in which case the voicemail system will either announce that there are no messages, or that there are a certain number of messages. The voice recognizer correlates for both possibilities and if the “no message” announcement is detected at step 190, the call is cleared down at step 200 and the algorithm stops. On the other hand, if the voice recognizer detects the announcement that there are messages, this preferably merely triggers recording in memory of everything from that point until a termination criterion is detected, for reasons outlined below. The termination criterion might be the voicemail system clearing down the call upon receiving no further instructions.

Navigating a voicemail system's state diagram by means of machine-understanding of voice prompts is the most ambitious goal of the invention. This is one way to collect voicemails with little or no user intervention from conventional voicemail systems that provide only this form of access, and no web-based, machine-navigable, server-based access. A fallback position in the case a particular voicemail system is difficult to navigate by machine is to enlist user assistance to recognize the voice prompts and to initiate recording and termination of each message by pressing keys. This can be made very convenient to use with few keypresses. Specifically, the user is relieved of having to enter the 10-digit number of the voicemail system; is relieved of having to enter his own 10-digit phone number, and is relieved of having to enter his password for the voicemail system. In the worst case, the user may be required to press a key indicating when he has understood the end of a voicemail message to have been reached or a new voicemail message to have begun. Enlisting user support to mark the beginning or end of voicemail messages in this way has been described in the prior art for the purposes of assisting a speech-to-text conversion of a voicemail message. In the present invention however, it would be used to assist in parsing the voicemail replay into individual messages for the purposes of causing each to be stored, still in digital audio form, in a separate file in memory.

Achieving the goal of full automation of voicemail retrieval, parsing into individual messages and removal of system voice prompts is however facilitated by the following insights:

(1) The voice prompts of a particular voicemail system are always exactly the same, spoken by the same voice at the same speed. This considerably improves the reliability of voice recognition for detecting them.

(2) Sophisticated soft-decision algorithms based on Markov Chains may be used, whereby instead of hard decisions as to what state has been reached, all possibilities are maintained in parallel, probabilities for each state are computed, and the state having the highest probability is ultimately selected at some suitable terminal instant.

(3) The ultimate goal of partitioning the entire voicemail replay into individual messages, extracting the time and date of receipt, and creating a file for each may be considerably simplified by relegating this task to offline processing wherein the stored audio dialog may be processed and reprocessed as many times as required to decode and parse it properly. Moreover, this offline processing does not need to be carried out in the smartphone or other user terminal, nor in real time, but may be carried out in an inventive voicemail aggregation device constructed according to the teachings herein. When the inventive voicemail aggregation device is a remote server, a user terminal may first record an entire voicemail system replay and then convey the whole digital recording automatically to the server over an Internet connection. Alternatively, in the second implementation, the user enables the server automatically to access his voicemail system directly by phone line or Internet to perform the task of parsing the replay into individual messages, for example by first recording the entire voicemail system replay and then parsing it by offline processing.

The goal of the offline processing of the entire replay recorded from a voicemail system is to partition the whole recording into individual messages, extract the time and date of receipt announced for each, and store each message in a file in association with its time and date. In some cases, the calling party may also be identifiable. The above is the function performed by one type of inventive adapter designed to navigate an existing voice-prompt voicemail system, when no other interface is available.

The above exemplary existing voicemail system announces replay of the first voicemail in the following way:

“First message, received Saturday December 12 at 3:25 PM”.

There then follows the actual first voicemail. At the end of the each voicemail, there may be an option to callback by pressing 1, to save by pressing 2 or to delete by pressing 3. As the message is being recorded by the invention, it would be appropriate always to issue a “3” upon detecting this prompt, which would however then have to be done in real-time. To avoid this real-time voice-prompt understanding task however, if no option is selected, the exemplary system does continue on to the next message after a short pause. At the end of all voicemails, the “replay” option may be selected to pass through the voicemails again, deleting them very quickly. Deleting messages that have already been recorded by the inventive voicemail aggregation server is desirable to avoid them being processed again upon a subsequent access to the voicemail system. Alternatively, voicemails already replayed and stored could be deleted the next time the invention accesses the voicemail box, after having processed the original recording offline to properly decode the number of voicemails and having parsed the replay into individual messages. Thus three options have been disclosed above for deleting voicemails from the carrier's voicemail system after recording them on the inventive voicemail aggregation server. Different carriers' systems may work more efficiently with one deletion method than with another. The selection of which method to use would be predetermined based on each voicemail system, and the determined method implemented in the adapter for that system.

After each voicemail is replayed, the exemplary voicemail system follows right on by announcing the next message similarly, if there is one. Voice recognition would attempt to extract the number of the message, verifying that it is sequentially one higher than the previous message, and the time and date of the message, verifying that it is later than an earlier message. The check for sequential message numbers and date/times provides a way to recognize mischievous attempts to fool the machine by sending a voicemail which is the recording of the output of another voicemail system replay. This in turn could contain a message which was the replay of another voicemail system replay, and so on ad infinitum. The audio stream of such a message would comprise valid system announcements but would exhibit out of sequence message numbers and non-sequential dates/times. If a message with a given number is detected twice in the audio stream, then the machine must determine which was the message and which was the message within a message, and the date/times can provide the clue to correct parsing. How much effort need be spent on making a system immune to such mischief is however debatable, but has been considered because the envisaged inventive server specifically provides the facility to forward messages from one voicemail system to another.

If real time detection of the prompt to delete, save or replay is the method chosen to delete already recorded messages, and the message within a message contains such a prompt, then at least the mischievous message will be deleted in its entirety early through its replay.

It is desirable for an offline parsing algorithm to be robust and reliable, and this is facilitated by the ability to process and reprocess the entire recording as many times as necessary with no real-time constraint.

Within a voice recognition algorithm, dynamic programming is usually employed to match each short audio segment with each of the possible expected audio prompt segments, and a mismatch factor, similarity factor or match probability factor is computed, which we denote by the general expression “delta metric”. Each possible position part way through the expected audio prompt is also given a cumulative metric, which is the accumulation of the delta metrics along the best path leading to that point.

Upon the matching algorithm path reaching an end point of a predetermined prompt, the cumulative metric is an indication of the reliability with which the prompt was detected. This is compared against the reliability of all other possible prompts and that which has the greatest reliability is used to initiate an instance of the subsequent action to be carried out. Several instances of the same subsequent action may be initiated at different times and accumulation of metrics continues from the previous value. A path which was initiated too early may fail to exhibit a high continued metric accumulation and will thus be overridden by a path that was initiated at a more optimum instant.

The operation of dynamic programming algorithms for the recognition of continuous, connected speech as well as isolated words has been known for several decades, and is further described in the following reference:

“Dynamic programming search for continuous speech recognition”, Ney, H and Ortmann, S, IEEE Signal Processing Magazine, Volume 16, Issue 5, September 1999, pages 64-83.

Syntactically constrained voice recognition is also known and developed in the art, in which sequences of words are limited to grammatically allowed sequences. In general, voice recognizers may contain “silence” of indefinite length as one of the allowed audio segments or “words”, so that gaps between words are recognized and correctly handled. Allowed sequences form Markov Chains, in which transition from one word or node in the syntactic state diagram to the next occurs with propagation of and accumulation of node probabilities.

When an error is made, such as issuing a phone number when a password was required, or vice versa, a different page of the state diagram/Markov Chain is entered that is constructed to represent the voicemail system's behavior in that event. Having different pages of Markov Chains/state diagrams corresponding to different erroneous action by the adapter at different places in the voicemail system's state diagram expands the total state diagram significantly, but still well within the capability of even a small processor by today's standards, and does not add much to the processing power required, while greatly improving the ability to recover from an error.

When voicemails are automatically retrieved from unrelated voicemail systems with the aid of a smartphone App as above, the user can determine how often the App should check for new voicemails on each voicemail system. Each smartphone deals with only one user, thus there is no bottleneck.

In the second implementation of this aspect of the invention, the user can require a remote server belonging to a voicemail aggregation service constructed according to the teachings herein, and on which he is a registered subscriber, to perform the polling for new voicemails. In this case, the server performs this function for a large subscriber base, with the result that bottlenecks can arise. For example, if the server were to place calls to voicemail systems by wireline, and the users had requested polling every 5 minutes, and it took 1 minute to determine that there were no new voicemails (which would be the case most often), then the number of telephone lines required would be ⅕th the number of subscribers, which is excessive. Fortunately, calls to landline numbers can be placed over the internet, using for example Skype.

Skype-type systems have placed concentrators in each dialing code area which are connected to the Internet at one end and to the local telephone system at the other. Thus a call can be directed over the Internet using Voice-Over-IP to a concentrator in the local area of a called number in order to bypass the long distance part of the telephone system. Thus the inventive voicemail aggregation server may comprise multiple instances of Skype-like software running simultaneously to allow a large number of simultaneous calls to landline voicemail system numbers without incurring the cost of long distance calls. Such a multi-number, Voice-over-IP system is sometimes known as an Asterisk Server. In the method of collecting voicemails by having unanswered calls forwarded from another operator's phone system, an Asterisk server can be used to receive the forwarded calls. By contrast, when the inventive voicemail aggregation server periodically polls other operators' voicemail systems, the Asterisk Server is being used to initiate multiple calls.

It will be understood by those skilled in the art of software that programs such as Skype-like VoIP software or voice recognition do not need to be duplicated in computer memory to provide several operational instances executing simultaneously, providing that the software is re-entrant and that each instance has its own data segment and stack segment. Thus an Asterisk Server can be used both to initiate polling calls to any phone system's voicemail number while simultaneously receiving forwarded calls from the same or a different phone system.

Thus when the inventive server activates an adapter to access a subscriber's Voicemail system and navigates through it, it preferably merely records the entire replay and then parses it into individual messages by offline processing, exactly as in the previously described first implementation where the smartphone participated in collecting the voicemail replay.

Some voicemail systems may provide better ways to access voicemails than via a dial-up number.

For example, it is possible using an Internet-capable smartphone or PC to visit the web page of certain carriers, enter a user ID such as a telephone number and a password, and view voicemails for numbers provided by that carrier on line, and select which to replay. It is also disclosed in the prior art that a smartphone may display voicemails that have been received on the voicemail systems of different carriers; however, in this prior art the user had to manually place a call to the voicemail system of each carrier to listen to a voicemail left on that carrier's voicemail system, and the voicemail was still “trapped within the phone system”.

It is also not known in the prior art to visit the webpage of one carrier to retrieve and replay voicemails left on another carrier's voicemail system; therefore automatic voicemail aggregation across multiple carriers' voicemail systems was not available. This problem is solved by the invention, which, in the last resort, uses a voice recognizer to navigate through the voicemail system's state diagram by recognizing voice prompts in order to perform the actions which a human subscriber would have done to listen to his voicemails. This must of course always be available to a subscriber, and therefore to an automaton mimicking the actions of a subscriber.

A more efficient voicemail retrieval system may be implemented If a documented digital interface exists with the voicemail server belonging to a particular telephone service provider, or for which the operation has been deduced though reverse engineering by a skilled and determined hacker.

Such a digital interface may be web-accessible and may provide voicemail header information such as the number of and identity of each voicemail, as well as separately selectable access to each voicemail, thus eliminating the need to use a voice recognizer for parsing voicemail replays for that system. This represents a second type of adapter that can be constructed for pulling voicemails from an existing voicemail service. Thus each voicemail system requires a particular, customized adapter to retrieve voicemails from it, based on the availability to 3rd parties such as the current inventors of documented or reverse-engineered interfaces to the voicemail system. Each adapter may have a corresponding section of software code in the inventive App that is downloaded and installed on a registered user's terminal and with which it may collaborate to perform the operations described above and herein below.

The registered user may wish to retrieve voicemails using different terminals, for example using a mobile phone sometimes, a PC sometimes or a Plain Ordinary Telephone (POT) at other times. The inventive voicemail aggregation server provides the greatest functionality to the user when accessed by an intelligent terminal, but may also, using the Asterisk type server mentioned above, provide multi-line dial-in access for POTs with reduced functionality.

In the case that a particular telephone system provides no voicemail service at all, but allows call forwarding, the inventive server can include a third type of adapter that implements a multi-number, Voice-Over-IP telephone terminal that records calls that go unanswered. While this could be used for all telephone systems, the subscriber would not then necessarily know by which telephone number a caller had attempted to reach him. This may be solved by having a different forwarding number for each of the subscriber's telephones. The inventive server can then aggregate the voicemails from all such forwarding numbers, as all the forwarding numbers are implemented on an Asterisk server within or co-located with the voicemail aggregation device and commonly developed and owned. The voicemail aggregation device can associate the forwarding numbers to the subscriber's various telephone numbers for display to the subscriber. The choice of forwarding unanswered calls to the inventive server or enabling the inventive server to pull calls from one of the subscriber's existing voicemail services is however left by the invention to the subscriber to decide.

In the case that one registered user using a cellphone or other suitable user terminal wishes to leave a voicemail message for another registered user, it is possible to offer “HiFi” voice, that is a voice coding method using a higher bitrate and not restricted to the 3.4 KHz top audio frequency of the telephone network or to the use of a low-bit rate vocoder. For example, voice messages may be left on the system using 16-bit PCM at 16 kilosamples per second, assuming that the user terminal has the ability to digitize speech at such a rate and to make it available to the App before compression.

Before the current invention, it was not possible to visit the web page of one carrier and see voicemails from a different carrier. The current invention may be implemented by a party other than an existing telephone service provider however, and by performing collection of voicemails across all carriers to the inventive voicemail aggregation server, allows the user to visit a single web page provided by the inventive server to view, select, listen to, pause, fast-forward, partially rewind, replay, quality-enhance, delete or share all voicemails. Furthermore, access to the inventive server may be offered under a license agreement by any existing carrier to that carrier's subscribers to enable them to access the voicemail systems of other carriers on which they are subscribers, thus overcoming those limitations of the prior art.

The inventive server can permit the user to sort the list of voicemails for display by any or all of
date and time of arrival
calling number (if known—not all voicemail systems will betray that)
called number on which the unanswered call was received

Furthermore, and in particular, the inventive server provides the facility for the user to share any voicemail with others by posting a hyperlink to it on any suitable internet medium, such as by embedding the hyperlink in an e-mail, or posting it on Facebook or other social site or “blog”, using a simple man-machine interface.

Upon logging in to the inventive voicemail aggregation server using a suitable user terminal such as a PC, the server will deliver a webpage to the web browser of the subscriber's terminal which is composed individually for each subscriber to display his messages.

One man-machine-interface for posting a hyperlink to a selected voicemail in an e-mail or to a social site or blog can be to drag and drop the symbol, icon or text string displayed for a voicemail in the list to an edit box that is already open for message composition. While this can be convenient when using a large-screen terminal such as a PC, it is not so convenient to have two web pages open simultaneously on a small-screen smartphone.

Consider the following two tasks in which the subscriber may be engaged:
(A) He is looking at his list of voicemails and decides to post one to Facebook
(B) He is on Facebook and decides to post a voicemail there

In the first case, scenario (A), a prior art proposal is to pre-load the voicemail server with Facebook login credentials, so that when the user is looking at his voicemails, he can select an option to “post to Facebook” and the server automatically performs the task of posting a voicemail. However, the disadvantage of this prior art is that the user has no choice over where it goes. Using Facebook nomenclature as an example, there is a location on a user's Facebook page called “user status” that the prior art may have envisaged as being the default location to which the voicemail server would post a voicemail. However, that might not be where the subscriber intends. Other possible intended locations could be to the “wall” of any one of a large number of friends, or to a reply composed to any one of a large number of other posts on Facebook. It would be so cumbersome as to be impracticable to have preloaded every possible such location to the voicemail server, and even if this were done, no method has been proposed in the prior art for selecting between them or for dynamically updating the list as Facebook acquires new messages to which replies may be solicited.

On the other hand, if Scenario (B) is considered, the subscriber is already logged into a selected social site and is positioned at an ad-hoc selected location on a selected webpage, such as reading another friend's wall, or composing a reply to a selected message, when he decides to post the voicemail link to that location. The user has thus already selected where a hyperlink to the voicemail should be inserted and it remains to select the voicemail in question. According to the current invention, this is done by providing an editor which has an “insert” option that, when selected, opens a dropdown box with “voicemail” as one of the options. When this is selected, a new window opens temporarily to display the list of candidate messages, which would be obtained by accessing the inventive voicemail aggregation server, if the list is not already downloaded to the user terminal. Upon clicking on one of the candidate messages, a hyperlink to it on the server is solicited from the server, generated by the server, transmitted by the server to the user terminal, and inserted by the editor in the designated place in the message being composed, the voicemail selection window then closing to avoid obscuring the user's original message composition task, which may be on a small smartphone screen.

Thus different Man-Machine-Interfaces are required for Scenarios A and B. For scenario (A) a convenient method for use with a smart phone is to provide a drop down list when clicking on a voicemail, offering the user the options of:
Listen
Delete
Post to Facebook
Send by e-mail
Post to site xyz etc

but the options for posting are necessarily limited. For a large-screen PC, on the other hand, it is possible to have both the voicemail webpage and the Social site webpage open at the same time, in which case dragging and dropping a symbol, icon or string from the voicemail page to the Social Site page is possible and convenient.

For scenario (B), while composing a message, a convenient method is to select “insert” from the editor toolbar, a dropdown box then appearing with the options of inserting, for example:
Special character
Picture, movie or other multi-media file
Hyperlink
Link to voicemail, etc.

In all these cases, the current invention uses the user terminal to effect the transmission of the message with the embedded voicemail link to the selected social website, in contrast to using the voicemail server to communicate directly with social site to perform the posting, with the attendant disadvantages outlined above.

Thus for Scenario B, upon selecting the option to insert a hyperlink to a voicemail within the editor, the editor invokes the inventive App to communicate with the voicemail aggregation server as necessary to temporarily display a list of voicemails to the user, the selection of one of which causes a hyperlink to the selected message to be solicited from the server and inserted by the editor at the place already opened by the user and where the composing cursor was last positioned. It may be noted that the composing cursor, usually a blinking bar or square in the current character position of a message under composition, is different than the mouse cursor, which may be independently moved to select “Insert” from the editor toolbar without changing the position of the composition cursor in the message.

A hyperlink comprises plain text bytes that are visible to a human reader as well as hidden bytes that describe the IP address of the link and which are only intended for computer use. For example, the visible text bytes may be:

“Mary's birthday greeting”.

while the invisible IP address part of the link might be

:href=“https://www.sharemailinc.com/ef2xstgyklr569.jsp”

or something even more cryptic. The link might be embedded in a text message starting with “Listen to” so that a person reading the message sees

“Listen to Mary's birthday greeting”

The words “Mary's birthday greeting” of the hyperlink would usually appear in blue and be underlined to indicate to the reader that this is a clickable link. The invisible part of the link directs the web browser of a person clicking on the link to a pre-prepared computer object on the voicemail server which is downloaded to the terminal of the user who clicked on the link, and who is not necessarily either the user who posted the link or the subscriber who left the voicemail, but more usually is a third party. The downloaded computer object may be a program written in html or javascript or any other language or mixture of languages which is executed for example by a java virtual machine on the user terminal to perform any one of a number of actions in addition to playing the voicemail audio file through a media player. One of the actions for example can be to verify that the link was clicked within the same web page to which it was originally posted as a method of restricting the audience to the originally intended subset. The current webpage on which the link was clicked may be retrieved by the App using one of the browser APIs provided by the OS. Thus the inventive App may convey information to the voicemail aggregation server in addition to the hyperlink string to facilitate this authentication. Likewise, during message composition, when a voicemail hyperlink is solicited from the server, the location where it will be embedded may be sent to the server as well as an indication of the selected voicemail, so that the server can generate a site-specific hyperlink.

Thus the inventive server stores both the human-readable text entered by the subscriber and the non-human-meaningful data it generates for the link to be posted. The owner of the voicemail aggregation registration may at any time edit the human-readable text that identifies a message by logging into the voicemail aggregation server and performing an edit function on this item in his tabulated message list.

Another action which can be performed at a third party's terminal upon clicking a hyperlink can be to open a pop-up window to display a prestored picture (mugshot) of the message originator, also downloaded from the server. The owner of the voicemail aggregation registration would have had to have provided this image when logged in on a previous occasion.

Yet another action that can be performed at a third party's terminal upon clicking the voicemail hyperlink is to open a pop-up box that displays an advertisement while the voicemail message is replaying. The window may close automatically upon the voicemail message terminating, or alternatively manually closing the window may terminate the replay of the voicemail message. Thus a 3rd party other than a telephone carrier may implement a basic voicemail aggregation and sharing service free of charge to many registered users, the service being paid for by advertising revenue. The advertising aspect of such a service may be characterized as displaying advertisements to a third party who clicks on a hyperlink to a voicemail left by a second party for a first party on any of the voicemail services to which the first party is a subscriber and which was shared in a post to a social site by the first party.

The inventive voicemail aggregation and sharing server also allows a previously shared voicemail to be retracted. If a message had already been posted to a site such as Facebook for example, the registered user of the voicemail aggregation and sharing service can be presented with a display of the sites to which he had already posted each message, and upon clicking on a site associated with a voicemail, the option “Retract from (site name)”. can be offered. By generating separate hyperlinks for each site to which a message is posted, it is possible to retract from one site while leaving the message accessible on another site. For example, the message could be retracted from being accessed by a multitude of friends on Facebook while being left accessible in an e-mail to a particular friend. The computer method by which this may be achieved may be alikened to “double indirect addressing”. The hyperlink would first direct the browser to a site-specific link in the inventive voicemail aggregation server. The site-specific link would contain the actual address to the voicemail file on the sever. However, upon retraction of a message from a specific site, the site-specific link can be replaced by a link to a page which says, in text or voice “This message has been deleted (or retracted)”

Thus because the inventive server does not post the audio file, or even a link to the audio file, but rather a link to a link to the audio file, which can be unique for each destination if desired, it is possible to retract an already posted message by having the server replace the target pointed to by the link with something other than the original message. The message is still stored in the server however, but that particular link no longer points to it. The link to the same message posted on other media, such as embedded in an e-mail, can however remain, as it can be a unique link for each possible posting destination. Knowing the site to which a message has been posted can also enable the server to deliver site-specific advertisements to a third party clicking on the hyperlink.

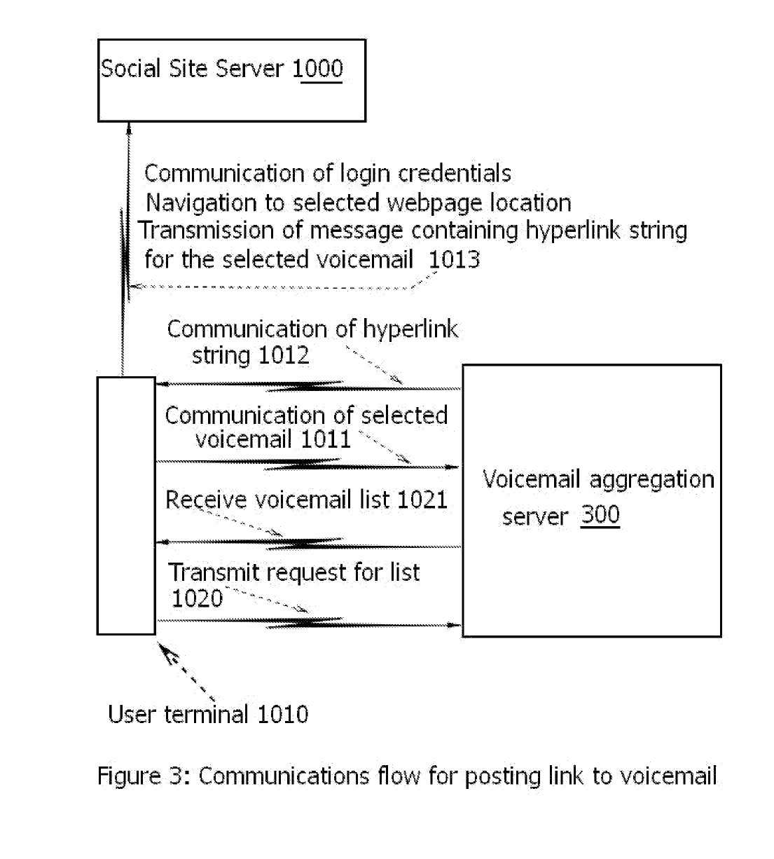

The information flow for posting a voicemail link is shown in FIG. 3. Three devices are involved: User terminal (1010); the inventive voicemail aggregation and sharing server (300) and the social site server (1000). Communications between these devices are illustrated by jagged arrows for simplicity, but it may be understood that such communications may take place over a variety of communications networks, including the Internet, to which access may be achieved by landline, cable, satellite, WiFi point or cellular mobile communications network as examples. It may be seen that there are no direct communications between the voicemail server and the social site.

In accordance with Scenario B, the user may have already logged in to social site (1000) by providing login credentials as part of the user terminal to social site server communications 1013. The user may also have navigated to a webpage on the social site and may be engaged in composing a message at a selected location on the webpage by use of an editor. Upon the user selecting to insert a link to a voicemail in a manner such as described above, the user terminal may transmit a request (1020) for a list of voicemails stored on server (300), if such a list is not already to hand and up-to-date. Server (300) replies by sending the list (1021) which is received at the user terminal and displayed in a pop-up box. The user then clicks on a voicemail displayed in the pop-up box, which causes the user terminal to transmit a request (1011) to server (300) bearing an indication of the selected voicemail and optionally an indication of the social site location on which it shall be posted. The latter indication is not a limiting element of the invention but is interesting due to the ability of sever (300) then to generate site-specific hyperlinks to a selected voicemail for the purposes of implementing the site-specific retraction feature described above. The server (300) then transmits the generated hyperlink string in communication (1012) to the user terminal. The editor that is open for composing the message to be posted then inserts the hyperlink in the message where indicated by the composition cursor. Upon completion of the message composition, the user causes the completed message bearing the hyperlink to the selected voicemail to be transmitted to the social site as part of user-terminal to social-site communications (1013). Social Site (1000) thereafter displays the message in such a way that 3rd parties may click on the hyperlink to listen to the voicemail. The hyperlink directs the web-browser to the indicated address on server (300) which is a pointer to a computer object that will deliver the voicemail to a media player linked to the web browser and also deliver one or more advertisements or other pictures and text for display while the voicemail is being replayed.

For scenario A, at registration and at any time thereafter, the user would have the option to indicate to the App stored in the user terminal, or to the server (300), or both, the different ways in which he could envision sharing the message, but would not need to perform the step of providing the voicemail aggregation server with login credentials to Social Sites. Instead, the login credentials are stored in the user terminal and made accessible to the inventive App which communicates with the voicemail aggregation server as just described for scenario B. The App is thus aware of the selected site for posting and uses the logon credentials to cause the user terminal to access the site to post the selected message with an embedded hyperlink provided by the server. The difference between scenario A and scenario B is that the user may transmit the request for voicemail list 1021 to voicemail aggregation server (300) before logging into social site server (1000). The user then selects the option to post a selected voicemail to social site (1000) from the options provided by the voicemail list display page, which can include save, delete, post to Facebook etc. The user terminal then transmits substantially the same request (1011) for hyperlink to the server as for Scenario B, indicating the selected voicemail and optionally the social site selected for posting. The server (300) then returns substantially the same hyperlink in communication (1012) for scenario A as it would have done for scenario B. The user terminal then logs in to social site server (1000) using the credentials stored in user terminal (1010) and posts the hyperlink to the social site server at a predetermined webpage location for that site, for example, in the case of Facebook, to the user's “status” edit box. Thus social site login credentials need never be provided by user terminal (1010) to server (300), simplifying the procedure for registering with server (300) and avoiding storing private information in a place where a security breach could cause its loss.

Thus whenever a message is shared by posting elsewhere a hyperlink to it on the inventive server in the manner described above, the recipient is directed to the inventive server upon clicking on the link. That initiates the downloading of a computer software object that will be executed by the target platform's web browser to further download the audio file which will be played on some suitable player such as Windows Media Player, as invoked by the target platform's browser. At the same time, the downloaded computer software object may provide the inventive server the opportunity to deliver revenue-generating advertisements in an unobtrusive pop-up box, or in the text section of the browser window, which provides a source of revenue that allows subscriptions to the inventive voicemail aggregation service to be kept to a minimum value or even zero. Further revenue opportunities for the provision of more advanced service options are identifiable by reference to the feature list that can be offered by the inventive system, which is reproduced below.

The Voice Mail Aggregation System will aggregate voice mail from diverse repositories into a central warehouse. The system is comprised of 4 components:
(1) Voice mail system interface—Used to pull voice mails from third party systems including:
   (a) Visual Voice Mail Servers
   (b) Voice mail systems provided by voice mail service companies
   (c) Voice mail systems provided by carriers
   (c) Digital voice mail machines on private lines
   (e) Analog voice mail machines on private lines
(2) Voice Mail Message Repository:
   Stores diverse messages in a common file format
(3) Voice Mail management system—organizes and provides access, security and searching
(4) Voice Mail User Interfaces—Provides for subscribers the access and control interfaces
   (a) Required to listen to saved messages
   (b) Required to listen to posted messages on social media

The Voice Mail Aggregation System will provide a comprehensive feature set to subscribers including:
(1) Ability to pull voice mails from many systems into a single repository
(2) Ability to access (hear or transcribe) voice mails
(3) Ability to sort, search, save, store and otherwise manage the collection of aggregated voice mails in a manner similar to email messages pulled from diverse mail systems
(4) Ability to group mail-boxes from multiple subscribers and manage messages as the group
(5) Ability for group members to access each other's messages
(6) Ability for group members to publish voice messages to group members
(7) Ability for subscriber to publish to a set of subscribers
(8) Ability to share messages with other subscribers
(9) Ability to post messages to social media
(10) Ability to secure messages from access by other group members
(11) Ability to impose a security hierarchy within groups (parental controls)
   (a) Preview before release
   (b) Block from view
(12) Ability to store messages for unlimited period of time
(13) Ability to recover deleted messages
(14) Ability to rank or prioritize messages for viewing
(15) Push voice mails to third party voice mail systems
(16) Ability to retract voice mails from social media
(17) Ability to invoke various voice quality enhancement processes

Subscriptions

Personal (Free)—

Subscriptions include aggregated voice mail for single subscriber. Unlimited number of messages stored for 12 months. Allows posting to social media

Family (Free)—

Subscriptions allow aggregated voice mail up to 6 family members to function as a group and includes parental security features to manage messaging, review, retrain or block messaging. Unlimited number of messages stored for 12 months. Allows posting to social media

Business (Free)—

Subscriptions allow a business to maintain a corporate message repository to comply with legal requirements of storage and preservation of messages and to allow security to keep messages confidential, public, semi-private, etc. Post to subscriber sets, post to non-subscribers, post to group. Unlimited number of messages stored for 12 months. Allows posting to social media.

Gold subscription upgrade (Paid)—

Allows the other three basic subscriptions to be upgraded to provide for unlimited voice mail storage duration and enhanced management features. No Ads.

It may be understood from the above specification that the inventive system envisions many features that are not available on normal voicemail systems.

For example, although the possibility is known in the prior art to establish a common voicemail box for a group of telephone users, such as a group of people who may be working on a common project, this facility was only available when the telephones concerned were extensions on the same PABX. Using the voicemail aggregation server of the current invention however allows such groups to be formed when they are geographically widely dispersed and use different telephone systems and carriers.

Another feature that can be provided on the inventive voicemail aggregation server is to allow each registered user to store a list of contacts. In effect, this is a remote storage facility for contact information that is often stored in a mobile phone's memory. A fast way for the user to load the contact information to the server is thus simply to select an offered option to upload his contact list from his mobile phone to his personal area on the inventive server. Moreover, a hierarchical privacy paradigm can be implemented as on Facebook, but with regard to telephone contact information, namely, the user may designate that a specific contact may be viewed only by his “friends”, or only by his “close friends”, by everybody or by nobody. To manage and use this feature, the server may provide web access to registered users to search for people by name or telephone number.

FIG. 2 shows a simplified block diagram of the inventive server (300). It shall be understood that boxes identified by numerals can represent hardware modules, software modules or a combination of hardware and software.

Servers are standalone computers than run continuously without human intervention to provide a function to remote user terminals via the Internet. As such, they do not necessarily have keyboards and displays, except as may be needed for maintenance or updating. A server may have many times the processing power of a typical home PC and in particular may have very high capacity communications interfaces. A server may also comprise an array of many such processors interlinked to achieve the desired capacity.

For the purposes of implementing the invention, a key feature of the inventive server (300) is the use of adapters (301A, 301B . . . 301E), which are primarily implemented in software, but which may also employ hardware interfaces.

Each adapter is configured to interface with one known voicemail system. For example, one adapter may interface with and be programmed to navigate through a landline telephone voicemail system such as the ATT-like system used herein as an example of a voice prompt system, and therefore may have a wireline telephone interface. Alternatively, it may have a VoIP interface with Skype-like software for performing the same function via the Internet. Different Landline telephone service providers will likely require different adapters to navigate their respective voice-prompt systems. For example, there could be a Verizon adapter, an ATT adapter, a Time-Warner adapter, a T-mobile adapter, an adapter to a subscriber owned answering machine or an adapter that enlisted the support of a user's mobile phone to retrieve voicemails from any system. Although Time Warner delivers telephone services by cable, along with TV and Internet service, the subscriber is reached by dialing a regular landline number. Adapters configured to automatically pull voicemails from existing voicemail services without participation by the user or user terminal were denoted above as “the second implementation”, while adapters that enlisted the help of the user terminal were denoted above as “the first implementation”.

Although a number of different adapters are required, the number of different hardware units required can be much smaller, as the adapters are implemented by having different software modules that are only loaded into executable memory when required. Such modules can form part of a Dynamically Linked Library routine or DLL. Thus when accessing one carrier's voicemail system, a software module adapted to that system is loaded and activated and uses the same hardware connection to a telephone line or Internet access as when a different software module is loaded and activated to access a different carrier's voicemail system. One high speed Internet connection can in fact support simultaneous access using different software adapters to many different carriers' voicemail systems.

Another type of adapter is one which communicates with a subscriber's smartphone via the Internet, to enlist the support of the smartphone in collecting voicemails, as was denoted “the first implementation” above. It is helpful to offload parts of this operation to the multiplicity of subscribers' smartphones, thus relieving the server of some call initiation load. To enlist the support of a smartphone, the inventive server comprises “App” store (302) which stores software, adapted to different makes of cellphone if necessary, that is downloaded over the Internet to the subscriber's cellphone upon registration. “Apps” may also be stored that are adapted to run on a user's PC, Laptop, Ipad or Tablet. One advantage of enlisting the support of the user terminal in aggregating voicemails is that, when the user terminal is switched on and registers with a network, it may receive notifications that new voicemails are available, thus obviating the need for periodic polling. The inventive App on the user terminal can intercept these notifications and either automatically pull the voicemail from the voicemail system and simultaneously or later, after storing it, transmit the stored message to the voicemail aggregation server, or else, via operation of the App, merely pass the notification to the voicemail aggregation server to cause it to retrieve the message, thus obviating the need for the server to perform polling of that voicemail system and reducing the airtime minutes used by a mobile phone.

Voicemail message server (303) is a software module that implements the user features outlined in the above specification for the service, generating all web pages that can be publicly or privately accessed, all active links thereon, performs storage of voicemails and delivery of advertisements when active links are clicked. The offline processing described above to partition voicemail replays into individual messages may logically be performed by each adapter, as it is likely that the algorithm will be somewhat different for different telephone carriers, due to their use of different voice prompts and voicemail system state diagrams.

In addition, the voicemail server can be caused by a subscriber to perform various voice quality enhancement processes upon a stored digital voice message file. For example, the following processes could be invoked:
(1) Changing or levelling the the volume level across a stored message;
(2) Reducing background noise by spectral subtraction (a process known in the art which is not further described here) or any other method;
(3) Pausing, partially rewinding and replaying a section;
(4) Emphasizing or de-emphasizing high or low frequencies using for example a graphical equalizer,
together with any other processes that are known in the prior art of acoustic processing or which may be specifically developed.

Internet communications interface (304) is a high capacity Internet communications interface that allows the establishment of very many simultaneous connections of different types, including delivering web pages to browsers, communicating with Skype-like local concentrators, downloading Apps to smartphones or PCs and collecting digital voice recordings from voicemail systems to be processed in an appropriate adapter. It may also communicate via the Internet with a central Ad server such as provided by Google.

Another type of adapter can provide interfaces with different answering machines, if that is the method the user has elected to receive voicemails at a location served by a landline or cable service. In the case where an answering machine can not be actuated remotely to replay voicemails, the invention contemplates solving the problem by offering the user a new hardware product to replace his old answering machine, which is also a feature of the current invention.

Now that computers, home networking and suchlike have become so economic, it is possible to contemplate every home appliance such as TV, dryer, refrigerator, even down to the toaster having a connection to the internet via a wired (Ethernet) or wireless (WiFi) home network, or via a direct telephone connection using DSL, or an internet connection using a cable modem. The general term coined for such devices is “Web Appliance”. The inventive answering machine that would be offered in this case falls under the general category of a “Web Appliance”. The inventive voicemail aggregation and sharing server described herein is also considered to be a a web appliance, and represents one way to implement the inventive voicemail aggregation device, in that case, by an apparatus that serves a large number of registered users.

Web appliances may communicate one to the other, providing their IP addresses are known to each other and they are equipped with suitable software to communicate. Thus one or more web-appliance answering machines associated with different telephone numbers belonging to the same or different subscribers can communicate with each other or with a server web-appliance to jointly implement a voicemail message aggregation function for a subscriber or group of subscribers. This implementation of an inventive voicemail aggregation apparatus may be regarded as a distributed, rather than centralized solution.

In general, in the expectation that the user already has either a DSL or cable modem with an Ethernet connection, the inventive web-appliance answering machine product can be provided with an Ethernet or WiFi connection to the modem and pass on one or more Ethernet connections to computers, wireless routers or other appliances by performing a router function itself. In addition, it can have a wireline interface to a telephone jack, and software to automatically answer a telephone call that is not answered after a predetermined number of rings. In the case the user has a DSL subscription for obtaining internet access, the envisaged web appliance answering machine would only need connection to a telephone jack and would internally contain the filter necessary to separate DSL signals from telephone voiceband signals and loop-disconnect signalling signals. This device is activated upon detecting ringing, and when the call is not answered after a predetermined number of rings, may issue a pre-recorded greeting and voice prompt to the caller to leave a message. The message may be stored locally prior to forwarding it to the inventive voicemail aggregation server, or else it may forward it simultaneously over the web, using DSL for example, thus collecting voicemails from the wireline and forwarding them directly over the Internet to the inventive server (300), being effectively a remote extension of one of the adapters (301), e.g adapter 301E. The voicemails so collected are retrievable using the user's PC or smartphone by logging into the appropriate web page provided by inventive server (300), or alternatively by dialling a number using a Plain Ordinary Telephone. An advantage of such an answering machine device is that it may capture any signalling from the telephone carrier that is provided only to the subscriber's telephone outlet, such as caller identification. It may be realized that such a function can also be provided by a PC having a telephone jack, as was common in the days of dial-up modems, and having the usual functions that were available for dial-up modem use such as ring detection, auto-answer and programmable signal processing of the received voiceband signal. In the voicemail application the signal processing would be performed to record the voicemail rather than to decode a modem signal.

Of course a user may not desire to leave his computer switched on all day as an advanced answering machine. Thus a much simpler, smaller, lower power and lower-cost product may be envisaged. Such a device would be so infrequently powered up, that it could operate from an internal battery kept charged by drawing a few milliamps from the telephone line, and so would be self-powered.

Alternatively, a DSL or cable modem or both can be combined with the answering machine functionality, a WiFi access point, an Ethernet router and a wired or cordless telephone handset to provide a home appliance with multiple functionality in a single unit, replacing the multiplicity of separate units used today, each requiring their own wall transformers for power and own cable to a telephone jack or cables to interconnect them.

A product as described in the previous paragraph can in its simplest form be an electronic unit having only a connection to a telephone jack. The telephone jack allows both voiceband signals and normal telephone signalling as well as DSL signals to be communicated to or from the networks. In one mode of operation as was just described above, a call received on the telephone line which is still unanswered after a predetermined number of rings is directed to voicemail. Either the inventive product issues a pre-recorded greeting and records the voicemail before passing it to an associated voicemail aggregation server over the internet using the DSL signals, or else it communicates in real time with the voicemail aggregation server using DSL, the voicemail server issuing the prerecorded greeting and receiving the voicemail for recording immediately afterwards, the inventive product merely acting as a relay.

FIG. 4 shows the internal elements of this simplest form of web-appliance answering machine, which only connects to a telephone jack. In some cases it may be used so infrequently that the power supply circuit PSU (860) can comprise a small battery that is trickle charged by drawing only a milliamp or so from the 48 volt telephone line supply as well as the greater current that is required to be drawn to signal the off-hook condition when making or receiving a call. In other cases where the device is used more often, for providing a computer with DSL service for example, it may require a wall transformer to power PSU 860. PSU 860 provides all the voltages necessary to power loop disconnect interface (830) as well as the other elements. DSL filter (810) is a band-dividing filter that separates the telephone audio and loop disconnect signalling from the much higher frequency DSL signals. The separated DSL signals are passed between the DSL modem (820) and the filter. The DSL modem decodes received DSL signals to provide digital data from the internet to processor (850). Conversely, digital data for transmission to the internet is output from processor (850) to modem (820) for conversion to DSL signals. Since it is not possible to connect two DSL modems to the same telephone line, if the subscriber desires DSL internet access for a computer, web-appliance (800) can conveniently also provide an ethernet interface (870) for connection to a PC for example. Alternatively it can connect to a WiFi base station, which, in a more advanced web-appliance, could be built into appliance (800) to provide higher functionality.

Telephone signals separated by DSL filter (810) are connected to loop disconnect interface (830). Loop disconnect interface (830) may include a hybrid transformer or electronic hybrid to separate incoming and outcoming audio signals that exist on the same 2-wire line. Loop disconnect interface (830) also includes ringing detection and a circuit to draw the required off-hook current during a call. Processor (85) controls the off-hook current to signal on/off hook and maybe also pulse dialling. More usually however, such devices employ tone dialling using DTMF tone pairs. Processor (850) receives a ringing indication from the ringing detector and counts the number of rings. When the call goes unanswered after a predetermined number of rings, the processor issues a voice greeting to the caller inviting the caller to leave a message. The voice greeting may be prestored in digital form in processor memory (850) or else may be fetched in real time from a remote server via the internet using the DSL connection simultaneously. The digitally encoded greeting is then output though Digital To Analog converter (840) to the outgoing audio line of loop disconnect interface (830). If the caller leaves a voice message, the incoming audio from loop-disconnect interface (830) is digitized by A to D converter (840) and passed to processor (650) where is may be stored locally in memory, or passed to a remote server or other web-appliance via the internet using DSL modem (820), or stored or buffered temporarily in memory (850) before passing to a remote device.

If voicemails are stored locally, a user may access the voicemails using any computer or smartphone. If the computer is connected to ethernet interface (870), no internet access is necessary, the web-appliance (800) having its own IP address by which the user's PC can access a webpage showing the stored Voicemail list. Moreover, the user's computer can access via the internet any other web-appliance (800) that he is authorized to access, in order to see voicemails received on another telephone number located elsewhere. There is no clear limit to the number of telephones, voicemails to which can be aggregated in this way. The user can select any voicemail stored on any web-appliance and choose to save, listen-to, rewind, replay, quality enhance or delete it, or post a link to it on social media. To allow the latter, web-appliance (800) would be configured to present both a public and a private interface with the internet. It may be realized that, providing web-access to information stored in web-appliance (800) is effectively affording it some of the characteristics of a web-server, except that its capacity to handle multiple-simultaneous accesses by a large number of users is more limited than a typical web-server, due to the limited data rate provided by DSL, or by a cable modem, whichever is used.

One web-appliance, which may be another single-subscriber web-appliance (800) or a multi-user user web-server, may be designated as the master unit and others may be designated to be slave units. The master unit may collect and store all voicemails received at all slave units thereby acting as a voicemail aggregation device. The master unit can be accessed wirelessly by a smartphone for example. Even when there is no master unit and all units store their own voicemails, a smartphone App can be provided that pulls up the information from all such web-appliances belonging to the subscriber in a single display, by accessing each over the internet using their unique IP addresses. The smartphone user may then click on any voicemail to download it from the relevant web-appliance (800)

In a second mode of operation of web-appliance (800), instructions can be received over the internet via DSL to cause the unit to place a telephone call using the analog telephone line. Thus, with a matching App on a mobile phone, PC or other suitable user terminal, a user who is remote from home can effectively use his terminal to make a call from his home phone line, or even remotely answer a call to his home phone line without the delay of call forwarding. Such a device can also be considered to be a remotely located part of one type of adapter for voicemail collection, the remaining part being located at the inventive voicemail aggregation server's site as in the arrangement of FIG. 2.

As stated above, the inventive voicemail aggregation server is also considered to be a web appliance. Conversely, any web appliance with a suitably programmable processor can be configured to implement a voicemail aggregation and sharing server according to this invention as just outlined. For example, a Personal Computer with an Internet interface, and if necessary an interface with a telephone network, which can be of the conventional loop-disconnect form or can be a Voice-over-IP telephone interface, both of these providing signalling signals indicative of ringing or of a telephone being taken off hook, can be programmed to aggregate voicemails from various telephones, including telephones having voicemail services provided by different, unrelated carriers. Alternatively the inventive web-appliance answering machine (800) can be configured to be capable of performing the same function. Either the web-appliance answering machine or a personal computer can be networked over the Internet with other similar devices owned by the same subscriber or different cooperating subscribers to aggregate voicemails from the associated telephones and make them available for display, replay, deletion or sharing via a social site. Thus the inventive voicemail aggregation and sharing server and service can be implemented entirely on subscriber-owned equipment by installing software configured to implement the invention. For example, a subscriber having telephone subscriptions in different countries such as France, Japan and the United States, each associated with fixed telephones installed there, can acquire web-appliance answering machines (800) or Personal Computers with inventive software installed and locate them at the location of the telephones, the devices then being networked via the internet to aggregate voicemails for display, deletion, replay or sharing using a personal computer, smartphone or other user terminal located anywhere in the world where Internet access is available.

The foregoing description concentrates on voicemails that originate from a telephone communicating in a telephone system, but which may be listened to on either a similar telephone or a suitable computing device belonging to the subscriber and configured to access the inventive voicemail server. The subscriber's computing device, e.g. a P.C., may however also be used to create voicemails using a program that resembles an e-mail program such as Microsoft Outlook Express. A PC can be equipped with a microphone, such as a USB microphone, for picking up a user's voice which is then digitized within the PC. PC's have included for decades a digital voice recorder such as that found in Windows XP under Programs-Accessories-Entertainment-Sound Recorder. However, there was nothing very useful that could be done with the resulting recording. Later recording programs such as Audacity provided multitrack recording and editing for music composition and stored the result in a standard audio file format such as .WAV, which could be e-mailed as an attachment to other parties. Such existing programs can therefore be used in conjunction with e-mail programs to implement a voice messaging system, which, however, lacks the full range of features described above for the inventive system. Therefore a new software program is described that extends the features of such a PC-based voice messaging system to include all of the features of the inventive voicemail system described above and which in addition provides an assurance of secure delivery.

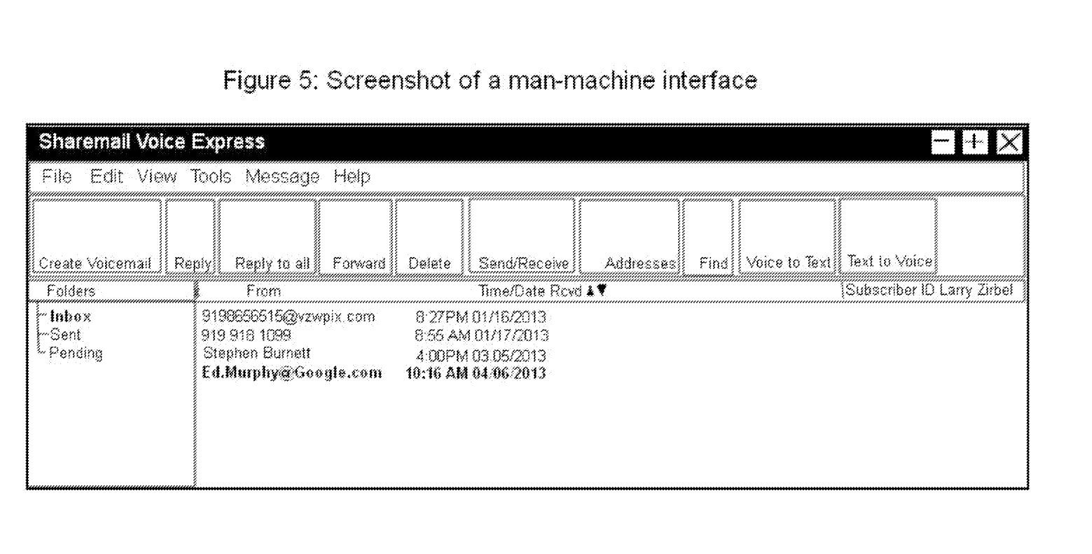

The software program is best described at a high level with reference to a screenshot of the man-machine interface as illustrated in FIG. 5. The resemblance of the screenshot to the e-mail program Microsoft Outlook Express is no accident. This is not so much plagiarism as the desire to minimize the effort needed by users to familiarize themselves with a new piece of software; thus keeping buttons that perform functions for voicemail in the same relative locations as those that perform similar functions for e-mail helps the user to learn to use the software quickly. Many software programs these days allow the user to choose which toolbars or buttons are displayed and where on the screen they are located relative to each other. It is therefore envisaged to have a configurable man-machine interface that can be selected by the user to resemble the e-mail program that he uses and with which he is already familiar. FIG. 5 is adapoted to a voice-messaging requirement, and other screens can be envisaged for other types of message, notably text or video. An overall screen can be provided inviting the user to specify whether he wants to peruse all types of message or only text types, only voice types, or only videomail types, and likewise when he wishes to compose a message he can invited to select type, so that the appropriate message display or composition screen can be presented. For example, to compose a videomail, it would be appropriate to display on the screen an image of the camera output to assure the subscriber that he was correctly aiming the camera.

Referring to FIG. 5, a number of toolbars can be seen. The top toolbar has buttons that allow the user to select to save or retrieve a received or sent message on his computer in a different place than the voicemail Inbox or Sent box. The Edit button allows the user to select to edit a received voicemail or just-composed voicemail which is in the Pending folder. The editing functions that can be provided have been described above and can include volume adjustments, volume levelling, tone controls, noise rejection and so forth. The View button allows the screen layout to be modified and also allows subsets of the messages only to be selected for display, such as messages received in a range of date/time intervals or from a particular source or class of sources, such as from telephone numbers only or from E-mail address only or messages only from people already in the Address Book, or messages only from family, messages only from business contacts or messages only from business contacts connected with a specific business or project. The Message button has the same selection as in the toolbar below plus filtering functions that allow the blocking of unwanted sources or voicemail spam, which is sure to arise if and when voicemail messaging becomes as ubiquitous as e-mail or Text messaging.

The second top toolbar contains the controls that allow creation of new voicemails, replying to a voicemail, replying to a group, forwarding a voicemail or deleting a voicemail. In addition, just like an e-mail program, there can be an address book which can be opened to select the destination address of a previous contact. Destination addresses can be telephone numbers anywhere in the world or e-mail addresses anywhere in the world, or the recipient's ID for a registered subscriber on the inventive voicemail server which will be sent in a header accompanying a transmitted voicemail to the IP address of the inventive server.

Messages can be received by an already-registered subscriber from another already-registered subscriber using the inventive system and replies can be made likewise. Messages can also be received by a registered subscriber from an unregistered subscriber if the registered subscriber has elected to have messages from other messaging systems aggregated to the inventive system. The unregistered subscriber sends such a message by any existing messaging system.

Voice messages may be sent from an already registered subscriber to an unregistered subscriber's e-mail address or telephone number, where they may appear, in the latter case, as voicemails on the unregistered subscriber's voicemail service. When however a voice message is sent from an already registered subscriber to an unregistered subscriber's e-mail address, and the unregistered subscriber opens the e-mail, a link will be found, clicking on which will open a webpage provided by the inventive server that contains script to open a pop-up window which will display text or images such as ads while simultaneously playing the voicemail through the recipient terminal's audio system. This script may also contain code to generate a security tokens for the as-yet unregistered subscriber and invite him to at least partially register so that he may receive securely delivered voicemails in the future. Electing to at least partially register will install the security application on the unregistered subscriber's terminal, create an account for him on the inventive server, and cause the unregistered subscriber to become a registered subscriber. The newly registered subscriber can choose during this process whether to have the inventive server aggregate messages from one or more of his existing messaging systems, or not.

The leftmost button in the second top toolbar is selected to create a new voicemail for sending. When selected, the installed system microphone is activated and a pop-up voice recorder control box appears having an oscilloscope display or bar display of the audio to give the user an indication of volume level and message duration. The recording control box also has fill-in boxes for the recipient or recipients. Recording may be stopped and started by a mouse button and terminated when complete. The recorded message ready for sending will then be visible in the Pending box and may be selected to be listened to and edited until the sender is satisfied.

Clicking on the send receive button will then scramble the message and transmit it to the inventive voicemail server along with security indicators that tell the recipient(s) terminal(s) how to descramble it. When finally sent, the message display moves from the Pending Folder. to the Sent folder.

The Inbox displays received message sources which may be telephone numbers, e-mails, or merely the names of previous contacts, the addresses of whom are already saved in the Address Book. The messages displayed may be sorted in ascending or descending date/time order or may be filtered using the functions already described for the View button.

Messages composed in the above way may be stored on the server in their scrambled form in a common message store, i.e. a message store that is not recipient dependent. On the other hand, the security indications that indicate to each recipient how to descramble the message are recipient-specific and are stored in a recipient-specific storage area akin to an In-Box. When a person accesses the server to retrieve voicemails, it can be arranged that the recipient-specific information which is much less voluminous than an entire voicemail, is downloaded first from the server to his terminal so that he very quickly gets a display of new voicemails, and only when he clicks to listen to one of them is the appropriate file in common storage then downloaded to provide the actual voice message bits. This recipient-specific information forms a header for each voicemail, which will be described in more detail below.

Each registered subscriber of the system is allocated more or less memory for storing voicemail messages that are yet-to-be received, or that he has not yet downloaded to his own computer, or which he wishes to remain on the server for the purposes of making them accessible to third parties by posting links to them on social media. Messages addressed to multiple recipients may be stored only once in a common, i.e. non-recipient-specific area of storage, but the number of messages of storage for which a registered subscriber has subscribed (if more than a default number) is still useful for the server to estimate the dimension of the common storage area. The amount of memory, or number of stored voicemails a particular subscriber is permitted to have before his voicemail box cries “full” may depend on the type or level of subscription.

Each subscriber's computer or terminal (k) is caused to generate and store in it's own memory a list of 2048-bit random numbers Rki corresponding to the permitted maximum number ‘m’ of stored voicemails on the server for subscriber ‘k’. Each random number is then used to generate a scrambled random number Tki, called a Token above, by the following equation:

Tki=MOD_{P2}[P1^{Rki}]

That is, in words, a first prime number P1 is raised to the power of the random number Rki and the result reduced modulo a second prime number P2 to obtain the Token Tki. All quantities are of the same order of wordlength as Rki, namely 2048 bits. The list of scrambled random numbers Tki (I=1, m) is then transmitted to the server so that the server has a reservoir of such numbers it can issue to a message originator to use for securing a message, even when the intended recipient subscriber's terminal is not on line and thus unable to participate in real time.

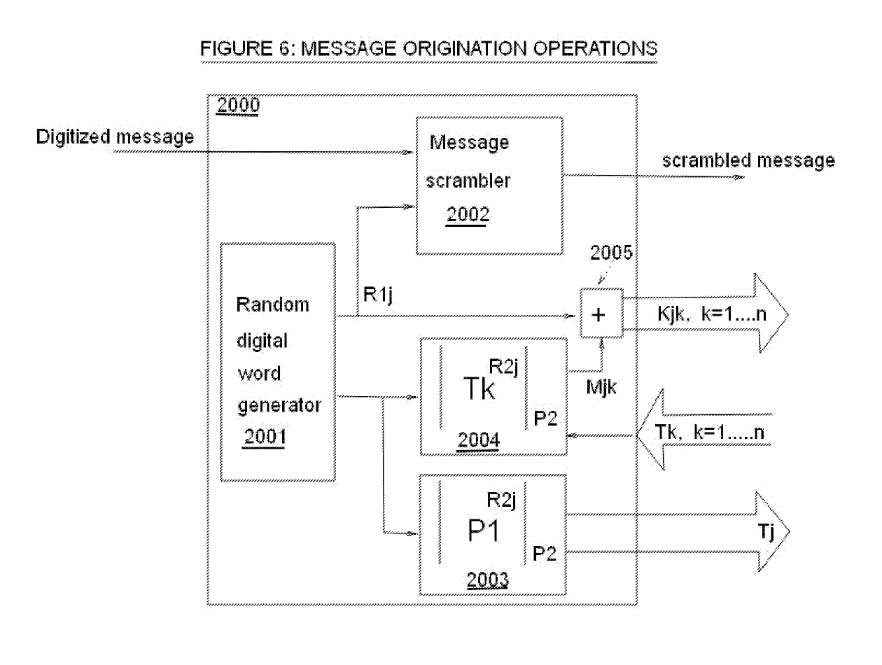

When a sender (j) desires to send a voicemail to a recipient (k), the sender's voicemail program requests the next Token Tk from the list Tki (i=1 . . . m) belonging to that recipient on the server. The sender's terminal then performs the operation indicated in FIG. 6 to produce the scrambled message, a value Tj to be included in the message header, and a scrambled token Kjk for each recipient, all of which are transmitted to the server.

FIG. 6 illustrates the transmission delivery security operation provided for messages originated in the above way by the inventive voice message system.

Unit (2000) of FIG. 6 may be implemented in software, hardware, or a combination of both. Unit (2000) accepts two inputs: (i) the message to be delivered and (ii) a list of Tokens Tk, k=1 . . . n that have previously been provided to the server by recipients 1 . . . n who are registered subscribers and which are stored on the server. Tk, k=1 . . . n are retrieved from the server by the voicemail Application running on the sender's terminal. Unit (2000) at the subscriber's terminal combines the two inputs to produce two outputs: (i) The scrambled message, and (ii) A list of scrambled tokens Kjk, k=1 . . . n, one for each recipient k=1 . . . n.

The detailed operation of unit (2000) will now be described. Random digital word generator (2001) produces a first and a second 2048-bit random number R1j and R2j respectively. R1j is connected to message scrambler (2002) where it is used as the scrambling key to scramble the digital message using any suitable symmetric scrambling algorithm to produce the scrambled message output. A symmetric scrambling algorithm is one in which the scrambling key and descrambling key are the same. Preferably, the algorithm does not have an error-extension property, whereby a single error in transmission/reception causes multiple errors after descrambling. For example, bitwise modulo-2 addition of a scrambling bitstream to the voice bitstream meets the no-error-extension property desired. Random bit pattern R2j is used as the exponent in a Diffie-Hellman operation to raise a prime number P1 to the power R2j, reduced modulo P2, to produce a message Token Tj, and to raise each recipient's token Tk, k=1 . . . n to the power R2j, reduced modulo-P2, to produce a message and recipient-specific mask Mjk which is added to R1j to produce a recipient and message-specific scrambled Token Kjk.

NOTE: It will be seen that each recipient-originated token Tk is raised to the same power R2j. This seems to have no discernible attendant security risk and slightly simplifies sending messages to multiple recipients. However, the invention could equally well permit the random number generator to generate further random numbers so that each recipient's token was raised to the power of a different random number. The former implementation, namely one sender-generated random number number in common for all recipients will henceforth be assumed in the following description, although it is considered to be within the scope of the invention to generate different random numbers per recipient.

The scrambled message is transmitted to the server where it is stored in the common storage area referred to above, while the scrambled tokens Kjk are transmitted to the server and stored in the recipient-specific storage areas referred to above. The word lengths of all quantities above, namely P1, P2, R1j, R2j, Tj, Mjk, Kjk and Tk (k=1 . . . n) are all typically 2048 bits (256 bytes). The digitized message may be much longer depending on its duration and on the voice bitrate used. For example, a 3-minute message digitized at 16 kilosamples per second, using 16 bits per sample linear PCM, would be 46 megabits or 5.76 megabytes. The facility provided by the invention of transmitting the message to the server only once, however many intended recipients (n) there are, is thus very important in avoiding transmission capacity overload. The only data transmitted per recipient are the 2048 bit (256-byte) scrambled tokens Tk (k=1 . . . n). This is an important aspect wherein the invention differs from other secure messaging schemes, and is motivated due to the large bitcount of voice messages.

The data that recipient k needs to descramble message j comprise the scrambled Token, Kjk, the sender's security token Tj and an indicator of which of recipient's precalculated Tokens Tk was used. These data are contained in a recipient-specific header transmitted associated with the scrambled message. The header for each recipient may be constructed by the sender or by the server. If the former, the server preferably tells the message originating terminal not only the values of Tk for each recipient but also which of the several precalculated and stored Tk's for each recipient was used, i.e. an index or other indicator of which of the Tki's was used for Tk. On the other hand, if the server constructs the header, since it knows which of the Tk:s for each recipient were supplied, it can itself fill in this detail in each header. Yet another alternative is to include the actual of value of Tk in the header; in that case, the recipient will need to scan his local store of [R2k, Tk] pairs to find a match fot Tk during decoding.

While the scrambled message is stored in a non-recipient specific storage area on the server, the scrambled Tokens Kjk are stored in a recipient-specific area and linked to the location of the message in common storage. When a recipient requests to download a voicemail message, the scrambled message may be retrieved from common storage and concatenated to the header that embodies, among other things, Tj from the output of unit (2000) of FIG. 6; the index i of the recipient's tokens Tki used (or else Tk itself); and the scrambled token Kjk. Other things normally forming part of a message header can include message source identification; date/time of origination stamps; an indication of the encoding sample rate and encoding algorithm used; the sample wordlength; the number of channels (e.g. mono or stereo), and CRC or sum check codes for the header and the message. Header items which are not needed until a recipient clicks on a message to listen to it need not be communicated in the recipient-specific header but may be communicated later in a message-specific header. The message with its own header and the recipient-specific message header will be sent to any requesting recipient's terminal. It is an optional implementation detail whether the header is pre-constructed for each recipient at the sender's terminal and transmitted to and stored on the server in recipient-specific memory (i.e. an In-Box) or else constructed by the server from the data supplied by the sender's terminal and held thereon until needed.

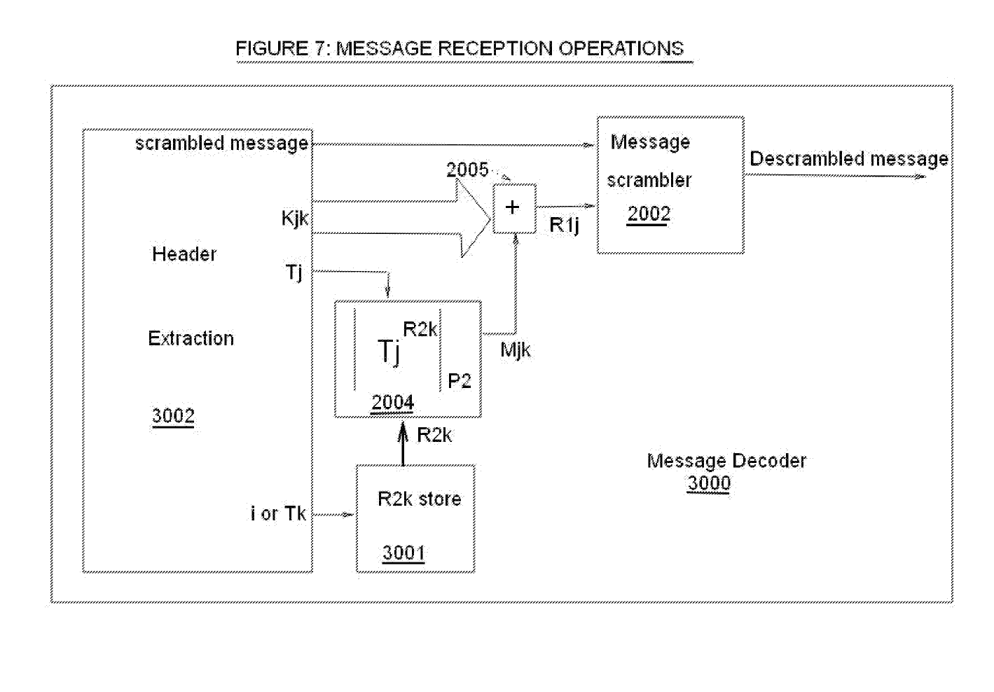

FIG. 7 illustrates message reception operations at the Terminal of recipient k. Message decoder (3000) may be software or hardware implemented, or use a combination of both. Some functions are in common with unit (2000) of FIG. 6 and are thus labelled identically. The message received from the server is decomposed by the header extraction unit (3002) to separate out the scrambled message bytes from the security indicators Kjk, Tj and I (or Tk). The indicator i indicates which one of recipient k's Tk values was used to produce the recipient-specific scrambled token Kjk at the originating terminal. If the Tk itself is included in the header rather than its index i, then the receiving terminal scans its R2k store (3001) containing [R2k, Tk] pairs to find the matching Tk, and hence R2k; otherwise the index i is used directly to look up the appropriate one of the R2k:s in store (3001). The recovered R2k is combined with the message originator's token Tj extracted from the header in Diffie-Hellman operation (2004) to reconstruct the Mask Mjk. Mjk is decombined from the Kjk recovered from the header in unit (2005) to obtain the descrambling key R1j, which is then used in message scrambler (2002) to descramble the message. It will be appreciated that bitwise modulo-2 addition and subtraction are the same operation, so unit 2005 still performs addition as the decombining operation when bitwise modulo-2 combination is used. Likewise message scrambler (2002) is the same operation for scrambling and descrambling when bitwise modulo 2 is used for scrambling.

The header items may already have been communicated to the subscriber terminal when it retrieved the list of new voicemails. In that case the scrambled voicemail itself, possibly with its own header of non-recipient-specific indicators, need only be transmitted to the subscriber when he selects a voicemail to listen to. The choice of pre-transmitting only the recipient-specific headers for each message first, followed by the scrambled voicemails only when asked for, is not considered a limitation of the invention, but rather an optional implementation.

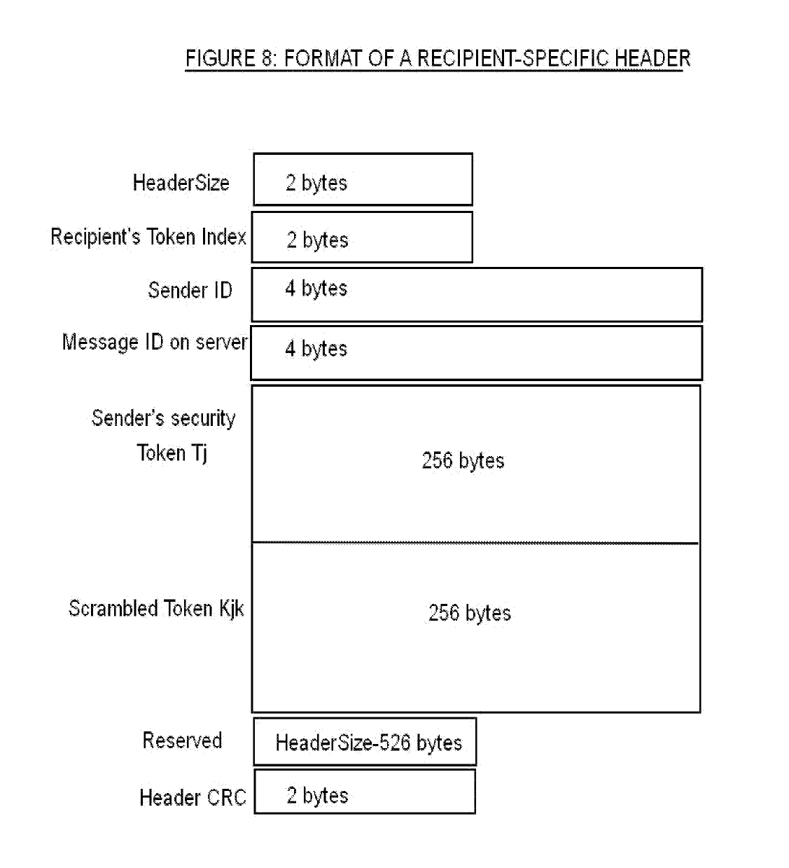

The file of scrambled digital voice bits may have a header of its own pre-pended. This header may contain other, non-recipient-specific data, such as an indication of the type of speech digitization used including wordlengths, sample rate, total message length, companding and number of channels, e.g. stereo versus mono and may contain the list of addressees, which is not recipient specific. Alternatively or additionally, the list of addressees may be sent in the recipient specific header, as it may be desired to display this in the message list before requesting download of any message. Examination of the recipient-specific header of FIG. 8 shows that the sender's terminal already has access to all of the information needed to construct it. Therefore it is an option whether the sender constructs it and transmits to the server each of the recipient specific headers, or whether the server performs this function from the recipient-specific date items supplied by the sender to the server, specifically the Kjk and the recipients' Token indices (i) Having the server construct the headers has the small advantage that the volume of header transmission from the sender to the server is reduced by a factor just less than two when a large number of recipients is specified. A system may implement both methods in dependence on the number of recipients, as an option

Header items and the message itself may have Cyclic Redundancy Error Detection codes (CRCs) embedded in the respective headers to obviate attempted decoding of corrupt messages. If anything is received with an error detected by use of the CRC, retransmission may be requested. Repeated transmissions may be soft- or hard-combined to produce a cumulatively improving probability of success as has been described in the art of error-correction coding and decoding.

FIG. 8 shows the layout of a typical recipient-specific message header.

The header of FIG. 8 begins with a 2-byte (16-bit) byte count for the header that allows for future addition of bytes into the “reserved field” as may be required for evolutionary purposes. For example, if a list of recipients was to be included in this header, it could be accommodated in this reserved space. The message length indicator indicates whether the reserved space is empty or contains data. The first byte of data in a non-empty reserved space can encode the type of extra data it contains.

The byte count allows for the correct location of the 16-bit cyclic redundancy check field at the end of the message, by which it can be verified that the header was received error-free. If the header is not received error-free, the terminal can re-request it from the server. The 2-byte recipient's token index follows. It is not envisaged that more than 65536 Tokens would be active at any time and numbers in this range would be recycled over time moculo-65536. Next comes the 4-byte Sender's ID on the server, the 4-byte Message ID on the server and the 256-byte Sender's security Token. While these items are the same for different recipients, they are included in the recipient-specific header because it is useful for the recipient to have this data early; as he will thereby know from whom the voicemail or other message was received and his terminal can start working on the initial descrambling steps 3001, 2004 and 2005 of FIG. 7 to obtain R1j. Because message originators can be defined by any of an e-mail address, a telephone number, a name or other method, the 4-byte sender ID merely encodes this along with a code that can be used by the terminal to access the actual ID format from the server for display on the terminal. Transmitting the header of FIG. 8 first ensures that the list of voicemails received is conveyed to the terminal rapidly. When the recipient then clicks on a displayed message to listen to it, the R1j will already be to hand to descramble it as soon as it arrives from the server.

A subscriber to the inventive voice-messaging system described herein first registers on the server for service the first time he accesses the server and receives an Application Software program which is downloaded from the server and stored on the subscriber's terminal. The Application Program performs initialization tasks including generating the random numbers Rki, storing the Rki (i=1 . . . m) in local memory, converting them to Tokens Tki, and transmitting the Tokens Tki (I=1 . . . m) to the server in accordance with the maximum number of messages expected to be stored on the server before deletion. Note that messages addressed to more than one recipient are only deleted from the common storage area on the server when all recipients have downloaded the message or otherwise signalled deletion. The subscriber may also, upon registration, transmit to the server his login credentials for one or more voice mailboxes he has for his various telephones, including telephones served by different, unrelated service providers.

After initialization of the App, whenever the recipient's computer is switched on, the App informs the server that it is available, and the server transmits a list of new voicemails or other messages to the terminal which may be displayed visually to the subscriber. Typically, an e-mail program such as Microsoft Outlook Express will download messages at that time and store them locally on the terminal. It is an optional implementation detail whether all new voicemails are downloaded at terminal start-up and whenever a new voicemail is received at the server, and the subscriber's App is running, or whether a voicemail is only downloaded when the subscriber first clicks on it in the displayed message list. Because voicemails are voluminous in bitcount, it can be advantageous to send only the header information and to delay transmitting the actual voicebits until the user selects to listen to a specific message. This is even more advantageous in the case of video messages which can have even higher bitcount. In the case of short text messages, or of any message of less than a predetermined bitcount, it could be decided that the system will always send such short messages at the same time as their recipient-specific headers.

It is also an optional implementation detail whether the server marks a downloaded message for deletion (for that subscriber) immediately after a confirmed successful download and descrambling operation or whether a grace period of a few days is provided before marking the message for deletion from the server after all recipients have read it. It is also possible for the subscriber to indicate to the server that the server should not delete the message by checking a box next to the displayed voicemail or other message to signal “mark as unread” to the server; then, despite having downloaded and listened to a voicemail, the voicemail will be retained on the server in scrambled form until further subscriber action. In the case of multiple recipients, if one subscriber's terminal has marked a message for deletion, the recipient specific information (Kjk, etc) is deleted from the subscriber-specific storage, but the message is retained in common storage until all recipients have deleted the corresponding recipient-specific data from their Inboxes.

After downloading a new voicemail or other message type, the recipient's voicemail Application program extracts the subscriber-specific Tokens Kjk and i (or Tki) and the message-specific Token, Tj, from the header. The value of i (or Tki) is then used to locate the corresponding value that generated it, Rki, in the subscriber terminal's local memory. The recipient program then unscrambles the voicemail by computing the following equation:

R1j=Kjk−MOD_{P2}[Tj^{Rki}] where “−” signifies the opposite of the “+”

operation in box (2005) of unit (2000) in FIG. 6. That is, the message Token Tj is raised to the power of the recipient's locally stored random number Rki, and. the result is reduced modulo P2. This reproduces Mjk which is then de-combined with Kjk to produce the message scrambling key R1j, which may then be used in the reverse process to message scrambling (2002) to descramble the message. The descrambled message may then optionally be stored locally on the recipient's terminal if it is desired to avoid repeating the above descrambling operations every time the message is to be listened to. This allows R1j, Kjk etc then to be erased from memory—otherwise at least R1j would need to be retained, with Tj and Kjk possibly being retained on the server by marking the message as unread. If R1j is erased, then the scrambled message can never again be descrambled by that subscriber. Therefore an indication to the server that a message can be deleted is that all recipients have deleted their corresponding R1j:s.

When a voicemail is selected to be published on social media, there is little point in maintaining it in a scrambled form. Since only intended recipients can decode a scrambled message, at least one of the intended recipients must have decided to publish the message. There are several ways that can be contemplated for publishing a previously scrambled message that are optional implementations, all of which are considered to fall within the scope and spirit of the invention.

To publish a message on social media, the recipient who decides to publish it indicates via the tools provided in the Application program running on his terminal that he wishes to do so, in the manner previously described above. A first optional method that the Application Program may then use to publish a previously scrambled message is to have first descrambled the message and returned it to the server in descrambled form where it will be stored without deleting the original scrambled message. The server will return an HTML link to the stored message to the subscriber as previously described above. The HTML link will then be embedded in a post on the social medium. A person browsing the social medium and clicking on the link will be directed to the server; the server will respond by downloading code that orchestrates playing of the unscrambled voice message that will be streamed from the server as well as opening a pop-up window for displaying visual information. The visual information could be any of: A mugshot of the voicemail originator; a progress bar; originator ID and date and time of origination and/or revenue generating advertisements. Because the voice message is audio, the display of visual information at the same time in a small pop-up window is not intrusive to the recipient's experience. It is thus believed that such advertisements will be more readily noticed than if the recipient's text-reading faculties were already occupied in reading a text message such as an e-mail.

A second method of publishing a message on social media is to descramble the message at the publishing recipient's terminal and then to return the descrambled message to the server to replace the original scrambled message. It is then necessary to edit all of the pertinent data stored in the multiple recipients' in-boxes to mark the message as already descrambled rather than scrambled. This is somewhat more complicated than the first method and has only the minor advantage of reducing message storage, without reducing any data transmission volume.

Current voicemail systems provided by telephone carriers provide unscrambled voice which may even be in analog form. Nevertheless voicemails retrieved from a telephone service will be digitized for use in this invention, and thus may be scrambled for storing on the server to avoid the server becoming a single point target for a privacy attack. In this case however, the sender is unavailable to participate in the scrambling. Another difference in this case is that there is always only a single recipient—the called subscriber.

To store messages retrieved from a telephone system on the server in scrambled form, the server may implement the operations of FIG. 6 exactly as previously described for running unit (2000) on a subscriber terminal. In this case however, only one Tk is input to unit (2000), being the next Tk in the list previously lodged by the intended recipient subscriber, and only a single corresponding Kjk is output along with the scrambled message. The unscrambled message may then be deleted from the server along with all other intermediate values not needed by the recipient to descramble the message. In particular, the value of R1j and R2j and Mjk generated by the server are no longer needed and are deleted. Tj, the selection i of from the recipient's Tki and Kjk are retained as long as needed to ensure error-free transmission of the header of FIG. 8 to the recipient.

When a message recipient elects to forward a received message to a recipient who was not originally on the list of recipients, the following method is used to maintain assured delivery security. The forwarding subscriber's Application Program first descrambles the message as previously described. Values of Tk for the recipients to whom the message is to be forwarded are then solicited from the server. The Application Program then generates a random digital word using random word generator (2001) but replaces part R1j of the word with the R1j obtained during the descrambling operation, while retaining the new R2j. Using the new R2j and the Tk of the forwarded recipients, operations (2003,2004) then produce the value Tj and a value Kjk for each of the forwarded recipients. The Tj an Kjk are then transmitted to the server to be utilized in constructing a new header for each of the forwarded recipients; alternatively, the new headers are constructed by the forwarding Application Program and sent to be stored on the server in the new recipients' In-boxes. Thus the same scrambled voice message already stored on the server may be used for the forwarded recipients as long as the appropriate new headers are used for each. The forwarded message headers may optionally contain a date/time stamp in the reserved bytes field for the time at which the message was forwarded as well as the date/time stamp of the message origination.

Further details of each of the sub-units of unit (2000) will now be described.

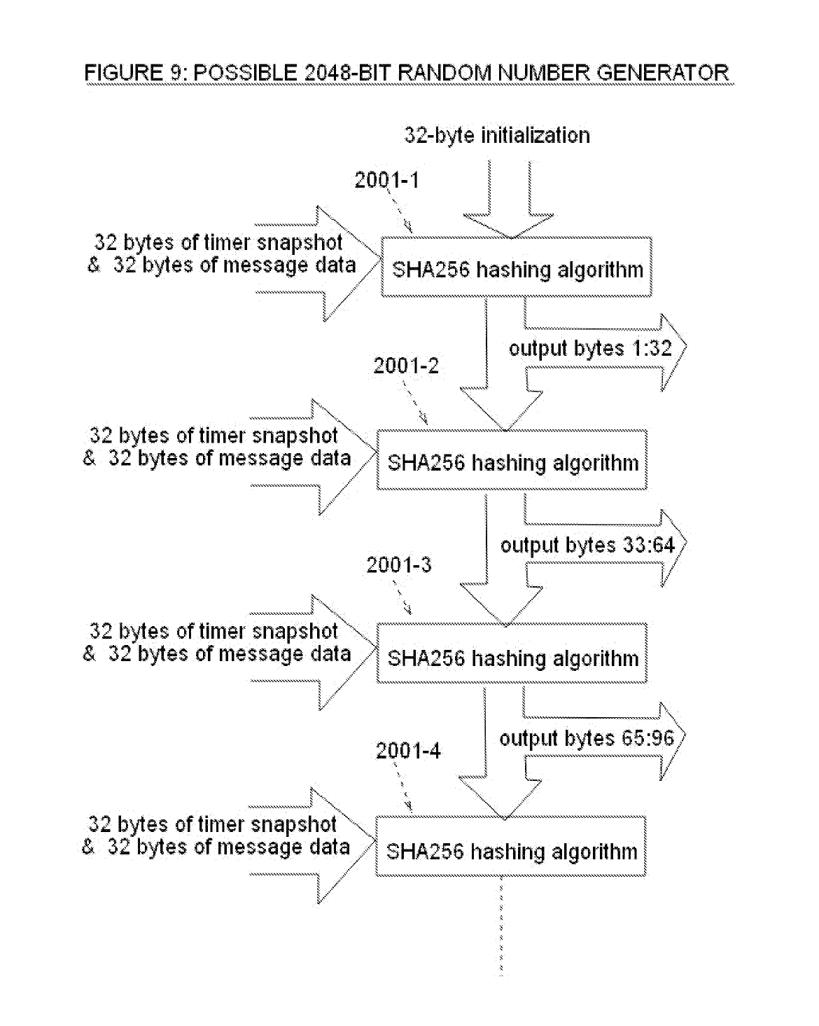

Random digital word generator (2001) is required to produce blocks of bits, that is 256 bytes, of unpredictable bits. Typically a PC generates a random number by taking snapshots of the X86's 64-bit CPU timer at various points in the program and using those values to seed a pseudo-random number generator. In this case, 32 snapshots of the CPU timer would yield 256 bytes of seed. For added randomness, if desired, some message bits, or a digest of the message such as a CRC code or a SHA 256 hash of the message can be mixed in to the pseudo-random number generator as it is running. There are many ways to construct such a pseudorandom number generator that operates on an initial seed to generate a random number that are well known in the art. For example, a long linear feedback shift register implemented in software can be used. Alternatively the SHA256 hashing algorithm can be used to mix 32 bytes of the message with 32-bytes of 4 CPU timer snapshots to produce a 32-byte hash of those 64 bytes, which is then repeated 8 times using different CPU timer snapshots and/or message data to obtain bytes of random output. The first iteration of the SHA256 algorithm uses the SHA256 table of prime cube root data as the initial state while subsequent iterations use the previous hash. The exact random number generation technique used is immaterial as long as it produces unpredictable output, and the method does not need to be identical in every user terminal. The SHA256 algorithm is likely to be available due to its use in securing digital currency transactions such as bitcoin transactions. Moreover, for the same reason, hardware chips have been produced to vastly accelerate SHA256 operation, should many such operations be required at the inventive server. A suitable design is illustrated with the aid of FIG. 9.

The exponentiation operations modulo P2 of sub-units (2003,2004) may be carried out using any of the recursive software or hardware implementations based on Karatsuba-Offman long multiplication or squaring as described in U.S. Pat. No. 7,113,593 to inventor Dent. et al and may use MMX SSE instructions or Graphics Processor Units (GPUs) having highly parallel integer arithmetic units to further increase speed.

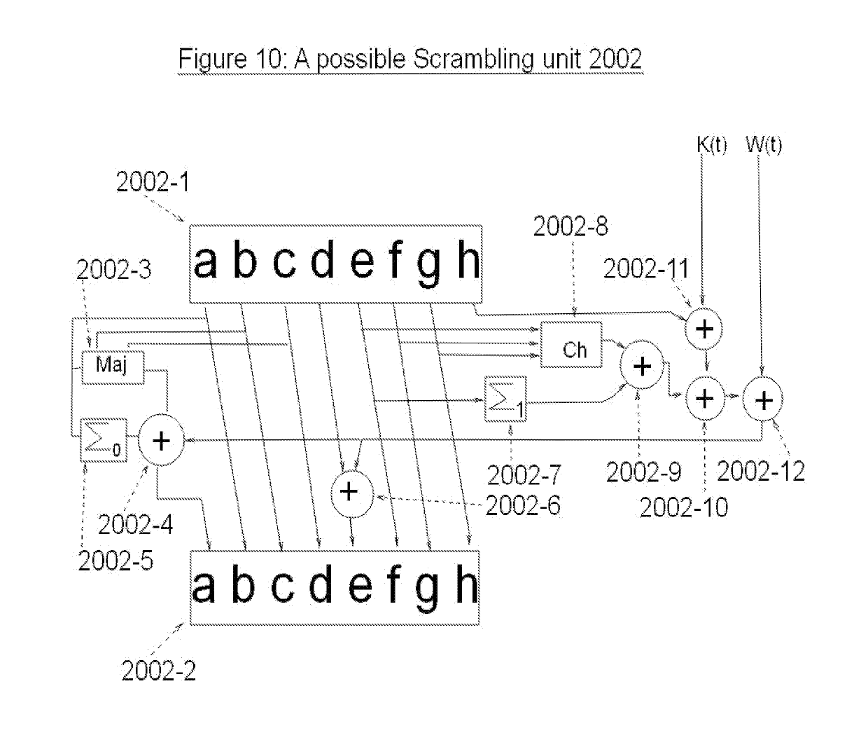

The message scrambling sub-unit (2002) scrambles the message bits, bytes or words using the random number R1j. R1j is used to seed a pseudorandom bistream generator to produce a stream of pseudorandom bits, bytes or words that are preferably bit-wise modulo-2 added to the message bits. The advantage of bitwise modulo-2 addition, also called Exclusive-OR, is that adding the same pseudorandom bits a second time undoes the scrambling. Moreover, a single error in transmission only produces a single error in reception, while other forms of addition typically produce a magnification of the error count. In principle, the same pseudorandom number generator, if intelligently designed, (2001) can be used to produce the message scrambling bits. FIG. 10 for example shows the use of SHA256 mixing stages for the scrambling. Each mixing stage (2002-1 to 2002-12) uses four functions of 32-bit arguments denoted respectively by Maj, Ch, Σo and Σ1, which are defined in a NIST document entitled

“Descriptions of SHA-256, SHA-384, and SHA-512”

and which is published by the U.S. Government on the Internet here:

csrc.nist.gov/groups/STM/cavp/documents/shs/sha256-384-512.pdf

The mixing stage of FIG. 10 comprises a starting state of eight, 32-bit words (2002-1) and produces a subsequent state (2002-2) also of 256 bits as follows: The first three 32-bit words of the starting state (a,b,c) become the three subsequent state words (b,c,d) and likewise starting state words (e,f,g) become subsequent state (2002-2) words (f,g,h). Stating state words (a,b,c) are also combined using the function Maj (2002-3) while a alone is operated on by the function Σo (2002-5). The outputs of the two functions Maj and Σo and the output of adder 2002-12 are then added in 32-bit adder (2002-4) to produce subsequent state word a. Starting state words (e,f,g) are combined in function Ch (2002-8) while e alone is operated on by function Σ1. The outputs of functions Ch and Σ1 are then added in 32-bit adder 2002-9, the output of which is 32-bit added to the quantities h and K(t) from adder 2002-11 in adder 2002-10, the output of which is furthermore added to W(t) in adder 2002(12). The output of adder 2002-12 is then added to starting state value d in adder 2002-6 to produce word e of subsequent state 2002-2 and to provide the third input of adder 2002-4.

The values K(t) are constants which are the 32-bit fractional part of the cube roots of the first 64 prime integers, and are used cyclically. The values W(t) are, for the first 64 values, the 64, 32-bit words of the 2048 bit random number R1j defined earlier. Subsequent values after the first 32 values of W(t) are defined by the recursion relation below:

Wⱼ=σ₁(Wⱼ₋₂)+Wⱼ₋₇+σₒ(Wⱼ₋₁₅)+Wⱼ₋₁₆

where the functions σ₁ and σₒ are also defined in the NIST document.

The operation of FIG. 10 derives a new subsequent state from a previous state for each new 32-bit word W(t) presented. The very first starting state is initialized to the first 8 values of K(t). Thereafter, the new starting state of each iteration is the 32-bit word-wise addition of the old starting state to the just-calculated ending state from the previous iteration.

Every 8 iterations, that is after use of eight values of W(t), the ending state (a,b,c,d,e,f,g,h) of eight 32-bit words comprising 256 bits in total is bitwise modulo-2 added to the next 256 message bits to be scrambled to produce the scrambled message.

Many variations of the above algorithm can be made by a person skilled in the art, for example, varying the number of W(t) words used between extracting each bits of scrambling sequence, or replacing 32-bit addition by bit-wise modulo 2, 16-bit wise of byte-wise addition. Moreover, any method of producing a continuous scrambling sequence of bits, bytes or words that depends strongly on the quantity R1j may be used without departing from the spirit of the invention, FIG. 10 merely being exemplary for the sake of completeness.

We claim:

1. An improved multi-media messaging device for providing a service to registered subscribers for transmitting messages to or receiving messages from other registered or unregistered users, comprising:—
A server connected to the Internet for providing access to said messaging service by computing terminals of said registered subscribers;
A storage memory connected to said server for storing a number of messages received for each subscriber;
Software running on said server for initially registering new subscribers and for receiving from each subscriber a number of precalculated security tokens from the corresponding subscriber's computing terminal for use in scrambling a corresponding one of said number of messages addressed to the subscriber prior to storage in said storage memory and also for receiving from each subscriber if desired login credentials for any of the subscriber's existing messaging services, including voicemail services provided by different, unrelated telephonic service providers.
Further software running on said server to receive requests from the computing terminals of already registered subscribers to communicate data for displaying a list of messages received and for communicating the messages and for transmitting the requested data or messages.

2. An improved multimedia messaging device for providing a service to registered subscribers for transmitting messages to or receiving messages from other registered or unregistered users, comprising:—
A subscriber terminal having computing capability for communicating with a message server and capable of rendering multimedia messages to the subscriber if human-understandable form;
Software running on said subscriber terminal for initially registering a subscriber and for precalculating and communicating to said server a number of security tokens each for use by said other users in scrambling a corresponding message, and also for providing to said server the login credentials of the subscriber's existing messaging services, including voicemail services provided by different, unrelated telephonic service providers.

3. The improved multi-media device of claim 2 in which said subscriber terminal further comprises:
A random number generator to generate random numbers having a binary word length equal to or greater than 512 bits and to store a list of the generated random numbers in local memory;
a Diffie-Hellman exponentiator to raise a first prime number to the power of each of said stored random numbers with the results being reduced modulo a second prime number to produce corresponding ones of said security tokens, said tokens being stored in local memory in association with the corresponding random number used to produce it, the thus-precalculated tokens then being communicated to said server at registration and further precalculated tokens being communicated to said server for use thereafter as required in scrambling new messages.

4. The improved multi-media messaging device of claim 1 further comprising
Adaptors, each configured to access and navigate through the voicemail services of said registered subscribers using said login credentials supplied at said initial registration and to retrieve new voicemails from said voicemail services provided by said different, unrelated telephonic service providers for aggregation and storage in said storage memory;
a scrambling unit for scrambling said retrieved voicemails prior to storage in said storage memory using for scrambling each voicemail addressed to a specific registered subscriber using a different one of said precalculated security tokens received from the subscriber terminal of said specific registered subscriber.

5. The improved multi-media messaging device of claim 2 in which said subscriber terminal further comprises:
A man-machine interface comprising a visual display for displaying data to the user and an entry device for receiving commands from the user;
software to interpret a command from the user received using said entry device into a desire to compose and send a message to specified recipients;
further software configured to request from said server in response to a detected desire to send and compose a message the next available security token for each of said recipients who is an already registered subscriber;
a random number generator to generate for each new message to be sent at least two random numbers having a binary word length equal to or greater than 512 bits;
a scrambling unit for scrambling a composed message in dependence on a first of said at least two random numbers thus to generate a scrambled message;
a Diffie-Hellman exponentiator for raising each of said recipients' security tokens to the power of a second of said at least two random numbers and for reducing the results modulo a predetermined prime number to obtain a mask for one of said already registered recipient subscribers;
A combiner for combining each of said mask with said first of said pair of random numbers to obtain a corresponding scrambled random number for transmission in a header to said one of said already registered recipient subscribers

6. The improved multi-media messaging device of claim 2 in which said subscriber terminal further comprises:
A man-machine interface comprising a visual display for displaying data to the user and an entry device for receiving commands from the user;
software to interpret a command from the user received using said entry device into a desire to receive a list of messages from said server, to receive and display said list on said visual display and to receive headers for each message containing security information specific to the recipient. including an indicator of a security token previously supplied to said server by the recipient, a token generated by the sender, and a scrambled token;
further software to interpret a user command into a desire to receive a specific selected message from said server;
a Diffie-Hellman exponentiator for raising said sender-generated token in the header corresponding to the specifically selected message to the power of a locally stored random number corresponding to said indicator and reducing the result modulo a predetermined prime number′ to obtain a mask;
a decombiner for decombining said mask from said received scrambled token to obtain a descrambled random number;
a descrambling unit for descrambling said specific selected message when received from said server using said descrambled random number.

7. A method of providing an improved multi-media messaging service to registered subscribers for transmitting messages to or receiving messages from other registered or unregistered users, comprising:—
performing an initial registration of new subscribers and receiving from each a number of precalculated security tokens corresponding to a number of messages to be received for each; and for receiving from each registering subscriber if desired login credentials for any existing messaging service of the registering subscriber, including voicemail services provided by different, unrelated telephonic service providers and storing said security tokens and said login credentials in association to the corresponding subscriber;
in response to a first registered subscriber indicating a desire to send a message to one or more second registered subscribers, transmitting to said first subscriber the next available security token stored for each of said second subscribers and an associated index; receiving from said first subscriber a scrambled security token corresponding to each of said second subscribers and a first-subscriber-generated token and receiving a scrambled message from said first subscriber.

8. The method of claim 7 in which said scrambled security token, said associated index and said first subscriber-generated token are contained in recipient specific headers received from said first subscriber for each of said second subscribers for storage in recipient specific memory storage areas and said scrambled message is stored in a non-recipient specific memory storage area.

9. The method of claim 7 wherein said said scrambled message is stored in a non-recipient specific memory storage area. and said scrambled security token, said associated index and said first subscriber-generated token are assembled together with a link to the message in said non-recipient specific memory storage area into a recipient-specific message header for each recipient, the recipient-specific headers being stored in recipient-specific memory storage areas.

10. The method of claim 7, having a sub-method for sending voice messages from a registered subscriber to an unregistered recipient, comprising:
Determining whether the unregistered recipient's address is provided as a telephone number, e-mail address or other form of address;
If said recipient's address is provided as a telephone number, ringing that telephone number and replaying the voice message to the telephone number or the voicemail service associated with that telephone number when indicated.

11. The method of claim 7, having a sub-method for sending voice messages from a registered subscriber to an unregistered recipient, comprising:
Determining whether the unregistered recipient's address is provided as a telephone number, e-mail address or other form of address;
If said recipient's address is provided as an e-mail address, constructing an HTML link, embedding said HTML link in an e-mail and transmitting said e-mail to said recipient's e-mail address, the HTML link when clicked on by the recipient reading the e-mail will deliver software code to the recipient's web-browser to open a pop-up window and to request, receive and replay said voice message while displaying visual information in the pop-up window, including an invitation to the unregistered subscriber to register, thereby to become a registered subscriber.

12. The method of claim 7, further comprising:
Upon initial registration, downloading and installing Application Software on the subscriber terminal of a newly-registered subscriber, the software providing a man-machine interface including display screens to facilitate the registered subscriber to compose, address and send messages to other registered or unregistered subscribers, to display messages received from other registered or unregistered subscribers, to select any displayed voice message to be replayed, and to open a pop-up window while the selected message is being replayed, the pop-up window having toolbars for selecting tools to permit the registered subscriber to perform any of the functions of replay, partial rewind, fast forward, adjust volume or tone or suppress noise, the pop-up window meanwhile until such tool is selected displaying revenue generating advertisements.
